(19) United States
(12) Patent Application Publication
(10) Pub. No.: US 2011/0082274 A1
(43) Pub. Date: Apr. 7, 2011

(54) NOVEL POLYUREA FIBER

(75) Inventors: George Phillip Hansen, Austin, TX (US); Richard J.G. Dominguez, Austin, TX (US); Nathan C. Hoppens, Austin, TX (US); Eric S. Shields, Austin, TX (US); John Werner Bulluck, Spicewood, TX (US); Rock Austin Rushing, Spicewood, TX (US)

(73) Assignee: Texas Research International, Inc., Austin, TX (US)

(21) Appl. No.: 12/822,567

(22) Filed: Jun. 24, 2010

Related U.S. Application Data
(60) Provisional application No. 61/220,354, filed on Jun. 25, 2009.
(60) Provisional application No. 61/222,292, filed on Jul. 1, 2009.

(51) Int. Cl. C08G 18/08; C08G 18/32

(52) U.S. Cl. 528/53; 528/68

(57) ABSTRACT

Aromatic polyurea fiber with improved modulus, strength, toughness and environmental resistance and method of synthesis.

This application claims priority to U.S. Provisional Patent Application Ser. No. 61/220,354, filed on Jun. 25, 2009, and to U.S. Provisional Patent Application Ser. No. 61/222,292, filed on Jul. 1, 2009, entitled NOVEL POLYUREA FIBER, the entire content of each of which is hereby incorporated by reference.

### STATEMENT OF RIGHTS TO INVENTIONS MADE UNDER FEDERALLY SPONSORED RESEARCH

This invention was made in part during work supported by a grant from the Defense Advanced Research Projects Agency (DARPA) of the Department of Defense, in the form of an SBIR Phase I project funded by DARPA and managed under oversight from the U.S. Army Aviation and Missile Command (Contract No. W31P4Q-09-C-0120). The government may have certain rights in the invention. This document contains information which falls under the purview of the U.S. Munitions List (USML), as defined in the International Traffic in Arms Regulations (ITAR), 22 CFR 120-130, and is export controlled. It shall not be transferred to foreign nationals in the U.S. or abroad, without specific approval of a knowledgeable TR1 export control official, and/or unless an export license/license exemption is obtained/available from the United States Department of State. Release or distribution of information is restricted under the Export Control Act.

### BACKGROUND

### I Polyureas

Formations of polyureas from diamines and diisocyanates have been described. Billmeyer (1984) cited aliphatic polyurea polymers, from aliphatic reactants. Though polymer fibers have long been made from synthetic materials ranging from urethanes, amides, acrylics, esters and many others, no fiber has been fabricated from a polyurea, and particularly not an aromatic polyurea. Polyurea formation chemistry and the physically hard or tough nature of its polymer products led to the widely held conclusion that these materials are intractable with respect to traditional production technology available before the 1980's.

Historically, compared with urethanes, polyureas have long been considered intractable substances from which to manufacture polymeric materials. High chemical reactivity of amines with isocyantes is difficult to control in conventional processing; but more importantly, the high crystallinity of the resultant polyurea products strictly limited further processing into useful products and materials. It was only through a series of developments, aimed initially as solutions to processing other polymer classes, that methods yielding viable polyurea materials became available.

Reporting on the melting points of various homologous polymers, Hill provided some of the earliest such data on urea-linked polymers in 1948, [Billmeyer (1984), reproduced in FIG. 3]. These data were plotted as functions of the number of chain atoms in the repeating unit; and extrapolation suggested certain polyurea homologues should melt at temperatures significantly above corresponding polyamides and urethanes. These predictions have been confirmed by more recent investigations, and today we know that these data are consistent with trends in cohesive energy density (CED) of these polymers, defined as ΔEᵥₐₚ/Vₘ, where ΔEᵥₐₚ is the energy of vaporization and Vₘ is the molar volume. In Hill's graphic reproduced in FIG. 3, CED increases as linkage unit density increases, and these increase as the number of chain atoms in a repeating unit decreases. Compared to other polymers shown, polyurea, polyamide and urethane polymers have high CEDs as a result of their significant degrees of hydrogen bonding. The inventors therefore hypothesized that the CED of certain urea-linked polymers would be exceptionally high, and this together with the unique symmetry of the linkage would yield materials having tensile strength and other mechanical properties well beyond those claimed by other commercial engineering polymeric materials.

Christian Weber of Bayer GmbH patented a diamine chain extender with optimal reactivity and useful for producing reaction injection molded (RIM) elastomers. The chain extender is called diethyltoluenediamine or DETDA (U.S. Pat. No. 4,218,542, issued Aug. 19, 1980), and was discovered as part of a large research effort within Bayer to find a substitute for 4,4′-methylenebis (2-chloroaniline) or MOCA. MOCA was a preferred chain extender for cast urethane polymer materials because of its aromaticity and reduced reactivity, but was classified as a carcinogen in 1973, so a replacement was sought.

Rice and Dominguez filed a patent which built on the Weber patent. This patent, issued Feb. 21, 1984 (U.S. Pat. No. 4,433,067), was the first granted in the United States claiming RIM polyurea materials. However, the principal focus of these early investigators was on development of large, elastomeric molded parts for the automotive industry. The polyether polyol-catalyst package in the Weber patent was substituted with a polyether polyamine, so no catalyst was needed. This polyurea system became the standard in the RIM industry, culminating in the Pontiac Fiero where it was used in all vertical body panels, and the front and rear bumpers. Later developments by Texaco Chemical Company in the 1980's led to spray application of polyurea coatings.

In 2004, Wilkes reported on thermal mechanical measurements from a series of homologous polyurethane and polyurea materials, with only one molecule in the hard block (respectively, meta- or para-phenylene diisocyanate), reproduced in FIG. 4. Wilkes' work was the first systematic study that quantitatively elucidated the role of the urea linkage with respect to the property distinctions between urethanes and polyurea materials. Surprisingly, the polyurea homologues, particularly the para material, had outstanding thermal dimensional stability, a property alluded to by Rice and Dominguez in 1984. The high level of thermal dimensional stability was surprising in Wilkes' para-urea homologue, because the hard block consisted on only one molecular linkage. This represented the first occurrence of such a small hard block domain, with such outstanding mechanical stability over a broad range of high temperatures.

In contrast to urethanes, polyureas have improved thermal stability, no thermal cycle buckling or warpage, and higher tensile strength and modulus. Recent evidence has emerged that indicates polyureas are preferable for their response to blast and ballistic forces, abrasion resistance, and fuel resistance. The high CED for polyurea materials accounts for much of this behavior.

The present invention represents a progression from a monodentate hydrogen bond to a bi-dentate hydrogen bond (FIG. 5). Greater hydrogen bond density between molecular chains in a polyurea impart greater CED to these materials over analogous polyamides.

### II Para-Aramid Synthetic Fiber

The properties of para-aramid synthetic fibers (e.g. Kevlar®) are due in large part to a series of intermolecular, mono-dentate hydrogen bonds as shown in FIG. 1. The bond energy of these hydrogen bonds has been estimated to be approximately 18.4 kJ/mol. Para-aramid synthetic fibers, for example Kevlar®, are spin cast into fibers from a solution in sulfuric acid. This accounts in part for their high cost.

Polyaramids can be made commercially by two practical synthetic protocols. The first is achieved by reacting an aromatic diamine with an aromatic diacid. In practice, this reaction is too slow to be commercially viable. The second method, the one used in commercial practice, is achieved by reacting an aromatic diamine with an aromatic diacid chloride. This reaction is so violent that safeguards need to be in place, and these increase the production cost by significant amounts. Both of these reactions produce by-products, water in the first and HCl in the second. These by-products, particularly HCl which is corrosive to equipment and workers alike, are the most difficult and expensive of the two to address. On the other hand, the reagents used in the investigation of the current invention for the synthesis of aromatic polyureas, aromatic diamines and aromatic diisocyanates need to be handled with care but do not pose the same threat level as an acid chloride. Also, the urea reaction is a polyaddition reaction with no by-products. Thus no expensive systems will be necessary to safeguard against accidental hazards associated with gaseous hydrochloric acid. All these characteristics of the amine-diisocyanate reaction will translate to very significant cost reductions and increased profits in the course of the large scale production of fibers.

The present invention provides a novel alternative polymer material comprising a series of intermolecular, bi-dentate hydrogen bonds. FIG. 2 shows an embodiment of an alternative polymer material provided by the invention. These bi-dentate hydrogen bonds are estimated to be 21.8 kJ/mol. Further, this reaction proceeds very quickly upon addition of the two reagents by way of polyaddition, with no bi-product. Therefore, fibers of this material can be reaction extruded, without the use of aggressive solvents, such as is the case with the encumbered production of para-aramid synthetic fibers, such as Kevlar®. Such a material could find many useful applications where para-aramid synthetic fibers are currently in place, but would not require such high bulk as the latter. Further, the bi-dentate structure should produce a fiber with much higher stiffness than para-aramid synthetic fibers. Stiffness may not be as high as that obtained in carbon fibers, but any improvement in this property is desirable with respect to many applications of para-aramid synthetic fibers, for example Kevlar®, such as ballistic protection and light weight structural composites.

### SUMMARY

The present invention provides a novel aromatic polyurea fiber material, and method of synthesis.

In one embodiment, the invention may comprise an aromatic polyurea fiber comprising paraphenylene-diisocyante (PPDI) and paraphenylenediamine (PPDA) linked via urea linkages to form a polymer. The number-averaged molecular weight of aromatic polyurea polymer may be between approximately 10,000 g/mol and 50,000 g/mol.

Another embodiment of the present invention provides a method of synthesizing an aromatic polyurea fiber material. In this embodiment, the method comprises the steps of adding a paraphenylene-diisocyante (PPDI) in anhydrous N-methyl-2-pyrrolidone (NMP) to a paraphenylenediamine (PPDA) and dehydrated calcium chloride to anhydrous NMP. This solution is then mixed vigorously until a change in viscosity occurs, vortexed in a great excess of ethanol, and filtered to collect the aromatic polyurea fiber.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a chemical structure of Kevlar®;

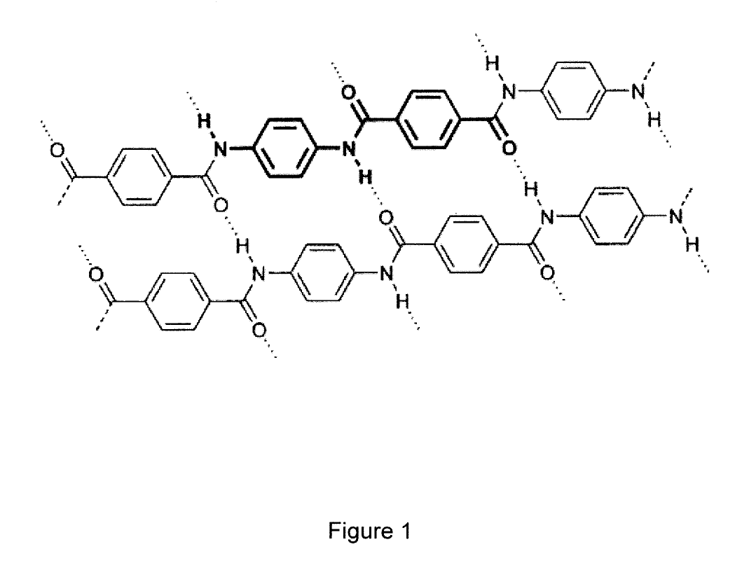

FIG. 2 shows a method of synthesis and a urea alternative to Kevlar®;

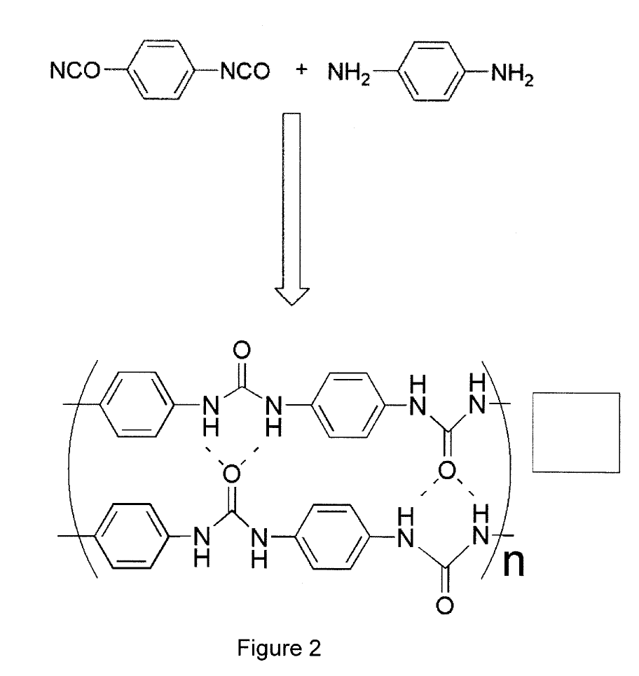

FIG. 3 shows the melting points of selected homologous polymer classes as functions of the number of chain atoms in the repeating units between the functional chain linkages, reproduced from Billmeyer (1984);

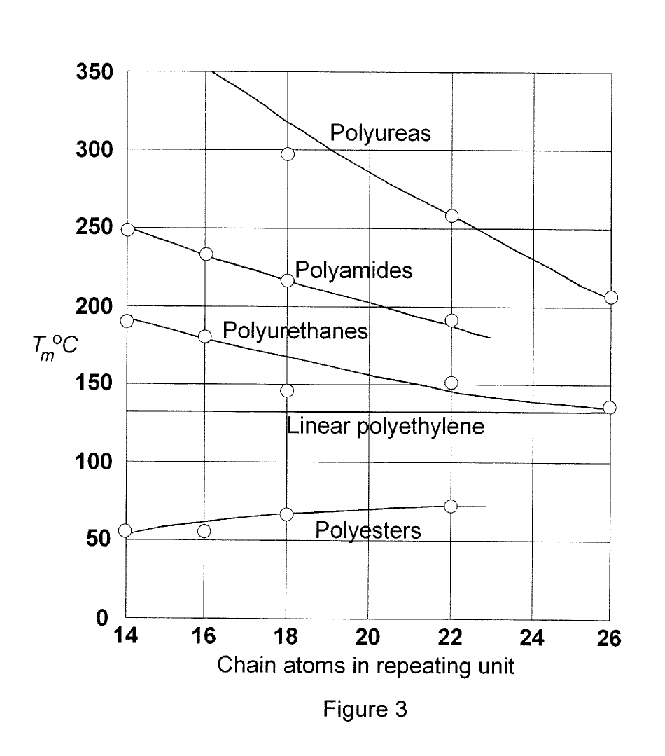

FIG. 4 shows a comparison of thermal stabilities of analogous urethane and polyurea materials;

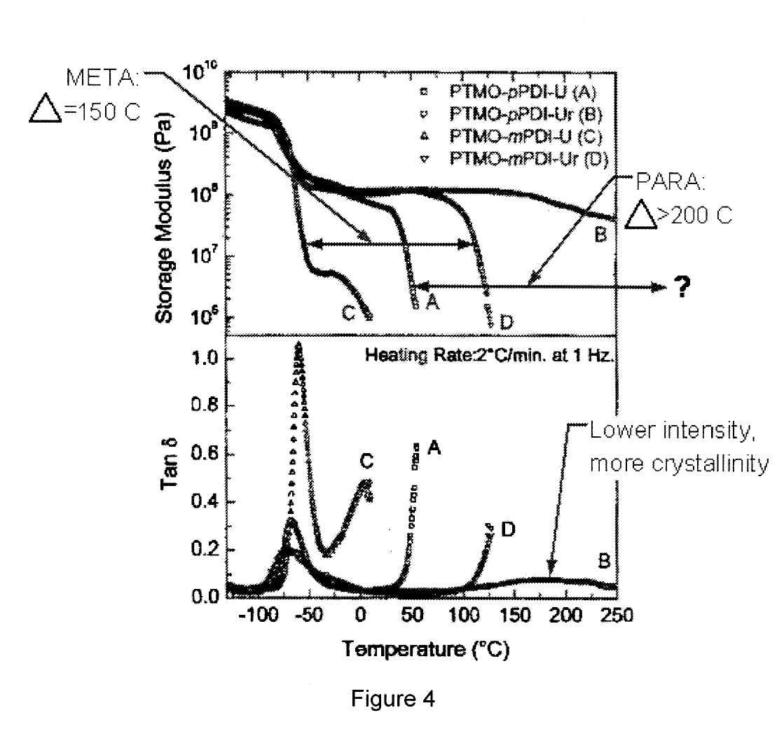

FIG. 5 shows a comparison of inter-chain hydrogen bond character in urethanes and polyureas;

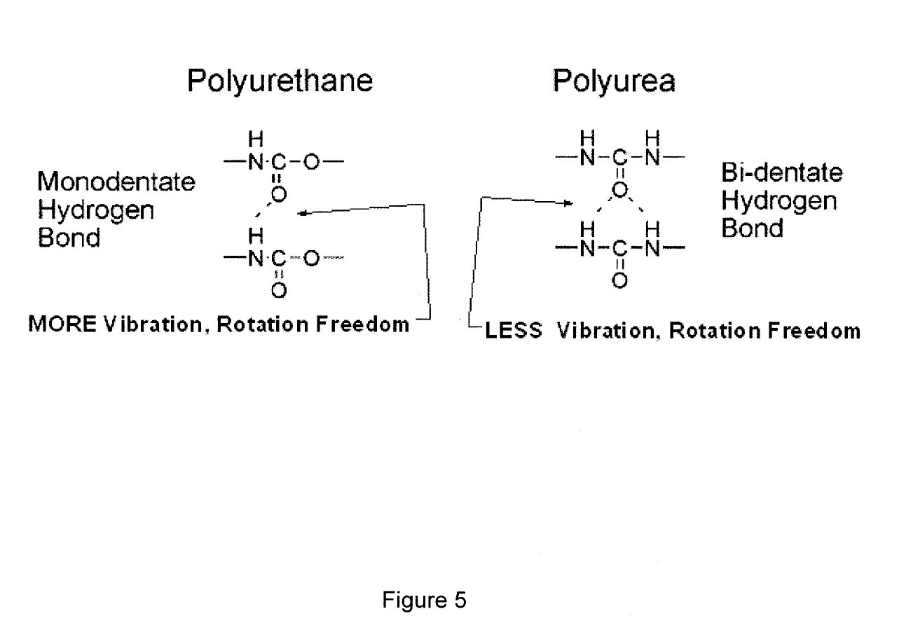

FIG. 6 shows a method of synthesis of a polyurea fiber material in an embodiment of the present invention. A possible chemical reaction scheme consistent with the invention is shown on the right;

FIG. 7 shows three Fourier transform infrared (FTIR) spectra stacked to show progressive reduction in characteristic reactant absorption peaks concomitant with appearance and growth of product peaks. These reactions were performed in para-dioxane;

FIG. 8 shows differential scanning calorimetry of a dry, equimolar mixture of paraphenylene diisocyanate and paraphenylene diamine. Temperature was ramped to 140.5° C. (just above the melting point of the isocyanate), held for 30 minutes at this point, and then ramped to 200° C.;

FIG. 9 shows a proposed reaction scheme involving a hydrogen-bonding blocking agent (CaCl₂) in accordance with the present invention;

FIG. 10 shows examples of reaction product solutions prior to quenching in water. Excess calcium chloride is evident in the right hand photograph as particulate matter adhering to the interior wall of the bottle. Experimental run numbers are shown: 35 (left) and 31 (right);

FIG. 11 shows initial reaction product following slow (left) and fast (center and right) quenching in de-ionized water. The arrow in the center image indicates the approximate region of the photomicrograph in the right image, which was taken at approximately 200× magnification;

FIG. 12 shows examples of quench precipitates (top) and associated quench solutions after filtration (bottom);

FIG. 13 shows the visual appearance of reaction media following quenching in vortexing water at three different temperatures. Experiment numbers shown: 45, 47, and 49;

FIG. 14 shows fibrous precipitate yield from homologous alcohol quenches. Experiment numbers shown: 69a, 69b, and 69c;

FIG. 15 shows fiber in the process of being drawn from experimental polymer solution no. 77 through a layer of ethanol. Arrows indicate the polymer strand being drawn in tension from the quench medium;

FIG. 16 shows structure of the drawn fiber according to the present invention. The left image was obtained at 30× magnification; the center at 200×, and the right image at 700×. Experiment number 77 is shown;

FIG. 17 shows a setup used for experimental trials 89, 91, and 93;

FIG. 18 shows initial thermal gravimetric analyses of two compounds according to the present invention in air and nitrogen. For comparison, a sample of Kevlar 49® (poly paraphenylene terephthalamide) was also run, after dissolution in hot H₂SO₄ followed by precipitation in water;

FIG. 19 shows thermal gravimetric analysis of thoroughly dried samples from experimental numbers 69 (left) and 73 (right) in nitrogen;

FIG. 20 shows thermal gravimetric analysis scan of partially dried film cast from experimental number 79;

FIG. 21 shows dynamic mechanical analysis in tension of a film cast from experimental sample number 79. Tensile storage modulus is approximately 600 MPa (˜87 kpsi). A peak in the Tan Delta curve suggests a T_{g} for this material of about 255° C.

FIG. 22 shows a comparison of the differential molecular weight distributions of an aromatic polyurea in NMP according to the present invention. Experimental numbers 77P, 79P, 87 and 89 are shown (see Table 4);

FIG. 23 shows short segment models of a polymer moiety according to the present invention from investigations of calcium ion attachment and hydrogen bonding of N-methyl-pyrrolidone (NMP) to the polymer during synthesis. The top model (A) shows the polymer alone. The middle model (B) shows Ca⁺⁺ attached to the carbonyl oxygens through the non-bonding electron pairs. The bottom image (C) includes Ca⁺⁺ and NMP hydrogen-bonded to the urea protons. Ca⁺⁺ also attaches to the NMP carbonyl group;

FIG. 24 shows a model of Kevlar® (poly paraphenylene terephthalamide) demonstrating that no symmetry element exists in the amide linkage. Calculated short-range structures of an embodiment of the present invention (left) and Kevlar® (poly paraphenylene terephthalamide, right) indicate that both materials are not linear or even co-planar. The crystallinity of these two materials should be roughly similar, based on molecular topology alone;

FIG. 25 shows a calculated structure of four molecular strands of polyurea material according to the present invention showing potential, medium range helical structure and intermolecular hydrogen bonding. Axial view is shown in A; lateral view in B; oblique lateral view in C; close view of the urea linkage center showing multiple, overlapping hydrogen bonds in D;

FIG. 26 shows a calculated structure of four molecular strands of Kevlar® (poly paraphenylene terephthalamide) showing potential, medium range helical structure and intermolecular hydrogen bonding. Axial view is shown in A; lateral view in B; oblique view in C; close view of the urea linkage center showing multiple, overlapping, hydrogen bonds in D;

FIG. 27 shows overlapping sphere renderings of Kevlar® (poly paraphenylene terephthalamide) (top) and a polyurea material according to the present invention (bottom) oriented with long axes parallel in the same inertial reference frame. Both models were constructed with the same number of repeat units and molecular strands;

FIG. 28 shows Hyperchem models of a single aromatic oligomer (top left) followed by three views of an aggregate of these molecules (top right, bottom left, and bottom right). Top left: Model of a single 32-unit aromatic polyurea molecule suggesting the spiraling structure remains over medium distances, but overall structure is random across the span of the entire molecule. This model represents a “Polymer” in the liquid or solution states where translational mobility is available. Bottom left: Model of an aggregate of 8 aromatic polyurea molecules containing 16 units each, shown from three different perspectives. Aggregate structure remains ordered over a large span of the “solid” material.

FIG. 29 shows a structure consistent with the proton NMR spectrum of “polymer solution 77c” according to the present invention;

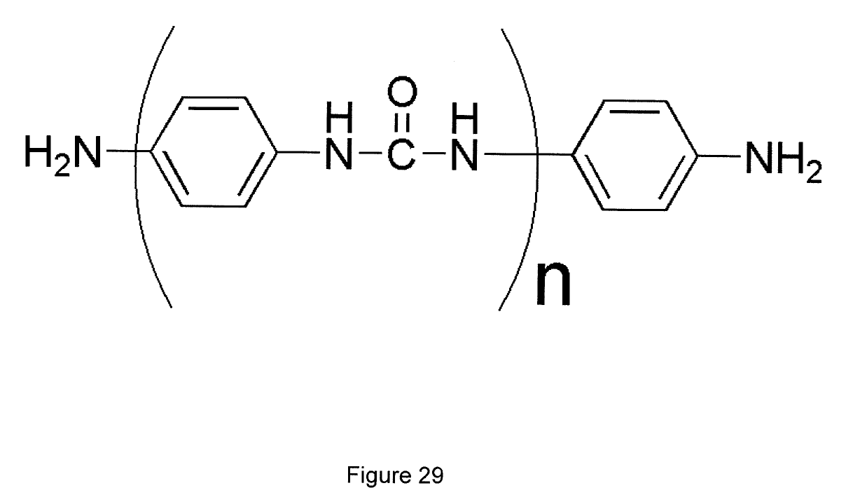

FIG. 30 shows an FT-IR spectrum of a product according to the present invention, sample “polymer solid 57a” made according to the specifications in Table 3;

FIG. 31 shows a proton nuclear magnetic resonance spectrum of a product according to the present invention, sample “polymer soln 77c” made according to the specifications in Table 3;

FIG. 32 shows an expanded portion of FIG. 31 from 1 to 3.8 ppm;

FIG. 33 shows an expanded portion of FIG. 31 from 4.5 to 10.5 ppm;

FIG. 34 shows an MWD curve of polymer in sample “poly soln 77c” (Chemir#590592): Relative Area % and Cumulative Area % vs. Log MW;

FIG. 35 shows an MWD curve of polymer sample “poly soln 79c” (Chemir#590593): Relative Area % and Cumulative Area % vs. Log MW; and

FIG. 36 shows an overlay of MWD curves of two polymer samples: Relative peaks are % vs. Log MW.

### DETAILED DESCRIPTION OF PREFERRED EMBODIMENTS

The present invention provides a novel aromatic polyurea fiber material, and method of synthesis.

### Aromatic Polyurea Fiber Composition

In one embodiment, the invention may comprise an aromatic polyurea fiber comprising paraphenylene-diisocyante (PPDI) and paraphenylenediamine (PPDA) linked via urea linkages to form a polymer. The number-averaged molecular weight of aromatic polyurea fiber may be greater that 10,000 g/mol, preferably greater than 25,000 g/mol, most preferably greater than 50,000 g/mol.

In another embodiment, the aromatic polyurea fiber may comprise the following structure:

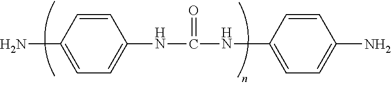

wherein n is approximately 50 or higher, preferrably approximately 100 or higher, most preferably approximately 200 or higher.

In an embodiment of the invention, the aromatic polyurea fiber material comprises a series of intermolecular, hydrogen bonds. In this embodiment, the hydrogen bonds may have an energy greater than 20 kJ/mol, preferably approximately 21.8 kJ/mol. In this embodiment, fibers of the material are capable of being reaction extruded, and produce a fiber with a higher stiffness than para-aramid synthetic fibers.

### Method for Producing Aromatic Polyurea Fiber

Another embodiment of the present invention provides a method of synthesizing an aromatic polyurea fiber material. In this embodiment, the method comprises the steps of: a) adding a paraphenylene-diisocyante (PPDI) to anhydrous N-methyl-2-pyrrolidone (NMP) to form Solution A; b) adding a paraphenylenediamine (PPDA) and dehydrated calcium chloride to anhydrous NMP to form Solution B; c) combining Solution A and Solution B to form Solution C and mixing vigorously until a change in viscosity occurs in Solution C; d) adding Solution C to anhydrous ethanol to form Solution D; and e) filtering Solution D to collect the aromatic polyurea fiber.

In one embodiment of the invention, paraphenylene-diisocyante (PPDI) may be present in Solution A at a concentration in the range of 10% to 50% by weight, based on NMP, preferably approximately 20% to 40%, most preferably in the range of 20% to 25%.

In another embodiment of the invention, paraphenylenediamine (PPDA) may be present in Solution B at a concentration of approximately 5% to 15% by weight based on NMP, preferably approximately 5% to 10%, most preferably in the range of 5% to 8%. The concentration of calcium chloride in Solution B may be approximately 10% to 40% by weight, based on NMP, preferably between approximately 20% to 30% by weight, based on NMP, most preferably 20% to 25% by weight, based on NMP.

The method of synthesis may further comprise a step of rinsing the aromatic polyurea fiber with a ketone, preferably acetone, and may also comprise the step of drying the aromatic polyurea fiber in an oven, preferably at above 30° C., most preferably at approximately 110° C.

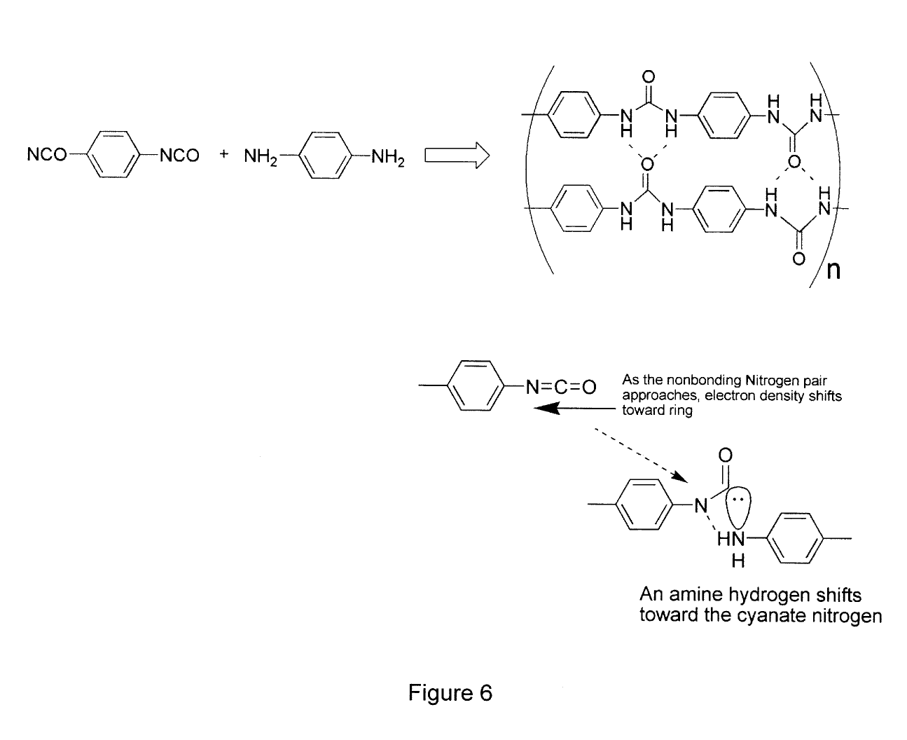

In an embodiment of the present invention, the synthesis of an aromatic polyurea fiber material may proceed according to the reaction shown in FIG. 6. Although not wishing to be bound by theory, it is speculated that the reaction scheme may occur as shown on the lower portion of FIG. 6.

### Example 1

### Purification and Preparation of Reagents

The reagents used to produce the desired aromatic polyurea polymer include an aromatic diamine and an aromatic diisocyante. Reagents used in the currently disclosed invention are listed in Table 1. These reagents react vigorously, resulting in an exothermic reaction. It is well known in polymer technology that maximization of physical properties is achieved only with a polymer of sufficiently high molecular weight. Three synthetic requirements are necessary to achieve this. First, purities of the reagents must be very high. The diisocyante readily sublimes and this property was used to purify it. The diamine was purchased at purity greater than 99%. Second, a suitable solvent for the reagents and subsequent polymer must be present in which to conduct the synthesis. Polymer solubility is important since the product must remain in solution in order to polymerize to a high molecular weight. Third, it is necessary to control stoichiometery, with the goal of achieving a 1:1 molar ratio.

TABLE 1
Reagents, Solvents and Materials Acquired Initially.

| Material | Source | Quantity | |
|---|---|---|---|
| Chemical Reagents | | | |
| 1,2-Phenylenediamine | Sigma-Aldrich | 100 | Grams |
| Product Code: P23938-100G | St. Louis, MO | | |
| 1,3-Phenylenediamine | Sigma-Aldrich | 100 | Grams |
| Product Code: P23954-100G | St. Louis, MO | | |
| p-Phenylenediamine | Sigma-Aldrich | 50 | Grams |
| Product Code: 78430-50G | St. Louis, MO | | |
| p-Phenylenediamine | Fisher-Scientific | 500 | Grams |
| Product Code: AC130575000 | | | |
| 1,3-Phenylene diisothiocyanate | Sigma-Aldrich | 1 | Gram |
| Product Code: 568937-1G | St. Louis, MO | | |
| p-Phenylene diisothiocyanate | Sigma-Aldrich | 5 | Grams |
| Product Code: 258555-5G | St. Louis, MO | | |
| 1,3-Phenylene diisocyanate | Sigma-Aldrich | 5 | Grams |
| Product Code: 308234-5G | St. Louis, MO | | |
| 1,4-Phenylene diisocyanate | Sigma-Aldrich | 100 | Grams |
| Product Code: 262242-100G | St. Louis, MO | | |
| Solvents | | | |
| 4-Chlorotoluene | Sigma-Aldrich | 1 | Liter |
| Product Code: 26550-1L-F | St. Louis, MO | | |
| n-Methylpyrrolidone | Fisher-Scientific | 1 | Liter |
| Product Code: AC12763-0010 | | | |
| Dimethylsulfoxide | Fisher-Scientific | 1 | Liter |
| Product Code: AC61042-0010 | | | |
| 1,4-Dioxane | Fisher-Scientific | 1 | Liter |
| Product Code: AC11711-0010 | | | |
| Tetrahydrofuran | Fisher-Scientific | 1 | Liter |
| Product Code: AC18150-0010 | | | |
| Hexamethylphosphoramide | Sigma-Aldrich | 100 | mL |
| Product Code: 52730 | St. Louis, MO | | |
| Sulfuric Acid 99.999% | Sigma-Aldrich | 100 | mL |
| Product Code: 339741 | St. Louis, MO | | |
| 1-Pentanol | Sigma-Aldrich | 1 | Liter |
| Product Code: 398268-1L | St. Louis, MO | | |
| 1-Butanol | Sigma-Aldrich | 500 | mL |
| Product Code: B7906-500ML | St. Louis, MO | | |
| 1 Propanol | Sigma-Aldrich | 1 | Liter |
| Product Code: 33538-1L-R | St. Louis, MO | | |
| Auxiliary Supplies | | | |
| DSC Cell (Aluminum Lids, Hermetic) | TA Instruments | 200 | Units |
| Product Code: 900794.901 | New Castle, DE | | |
| DSC Cell (Aluminum Pans, Hermetic) | TA Instruments | 200 | Units |
| Product Code: 900793.901 | New Castle, DE | | |

Isocyantes were purified by sublimation, allowing separation of the essential diisocyanate from undesirable dimerization reaction products.

Subsequent preliminary efforts involved determinations of solubility of the primary reactants, p-Phenylene diamine and p-Phenylene diisocyanate, in various organic aprotic solvents, to assess their suitability as carrier media for the reaction and polymer product. These solvents included toluene, parachlorotoluene, dichloromethane, tetrahydrofuran, para-dioxane, dimethylsulfoxide, methylethylketone, n-methylpyrrolidone, and hexamethyl-phosphoramide, see Table 2. The diisocyante was soluble in all of the solvents investigated. The diamine was soluble in all but toluene and parachlorotoluene. Solubility for the diisocyante appeared greater than the diamine in all of the successful solvents, even though all solutions were restricted to 0.1M concentration. Color changes were observed upon dissolution of the diamine in most cases, but not with the diisocyante.

TABLE 2
Summary of Reactant Solubility Studies

| Solvent Structure | Name | Results |
|---|---|---|
| 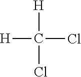 | Dichloromethane (DCM) | Both reactants soluble (0.1 M). Reaction instantaneous. Product quick to evaporate leaving precipitate residue. |
| 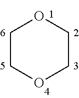 | 1,4-Dioxane | Both reactants soluble (0.1 M). Reaction rate intermediate between DCM and NMP (see next row). Modest heating required to remove solvent |
| 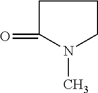 | N-Methylpyrrolidone (NMP) | Both reactants soluble (0.1 M) After preliminary investigation, we switched reactant concentrations to 8.0% amine and 7.25% isocyanate by weight to balance stoichiometry. Reaction visible slower than in Dichloromethane. Product slow to evaporate leaving fibrous precipitate residue. CaCl₂ predissolved in amine solution sides prior to mixing |
| 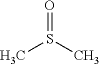 | Dimethylsulfoxide (DMSO) | Both reactants soluble. Sulfoxide group reacted overnight with isocyanate and forms a clear gel. Reaction not attempted |
| 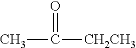 | Methylethylketone (MEK) | Amine fully soluble (0.1 M). Isocyanate only partially soluble. Reaction not attempted. |
| 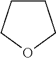 | Tetrahydrofuran (THF) | Both reactants soluble (0.1 M). Reaction attempted but product did not remain in solution. |
| 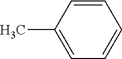 | Toluene | Amine not soluble Isocyanate only partially soluble. Reaction not attempted. |
| 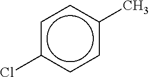 | Parachlorotoluene | Amine not soluble Isocyanate only partially soluble. Reaction not attempted |

### Example 2

### FTIR Spectroscopic Analysis of Reactant Solutions

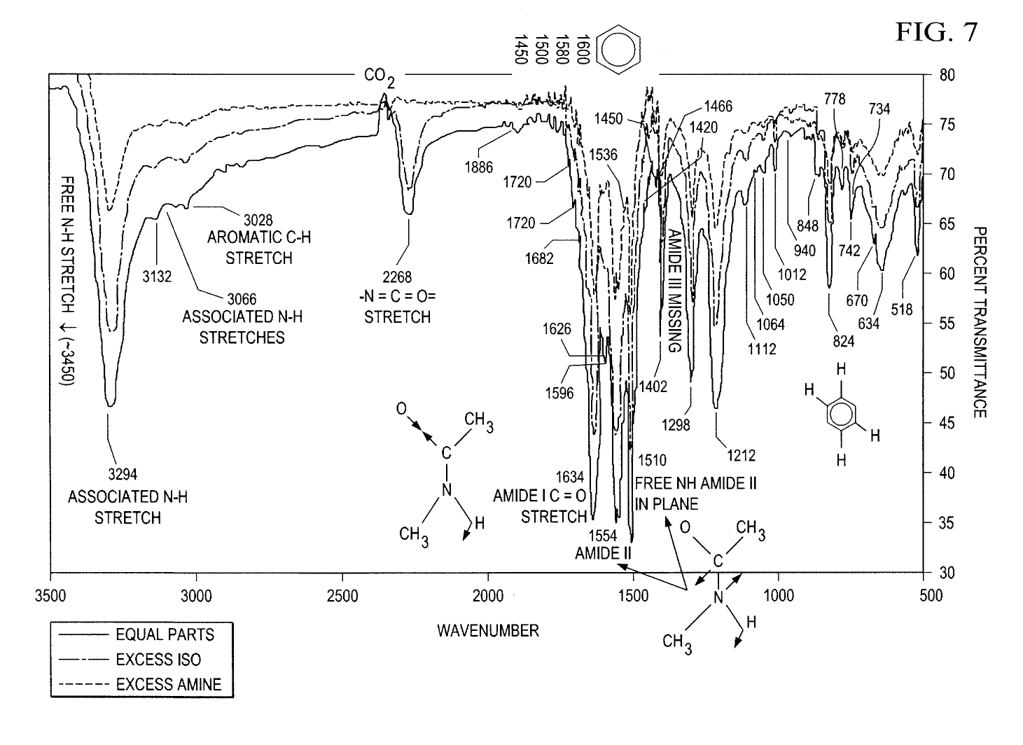

Initial mixture reactions were performed on a small scale to confirm that results could be observed using standard (Fourier transform infrared) FTIR spectroscopy. In this case, mixtures were made in para-dioxane with three different molar ratios of the reactants: excess isocyante, excess amine and equal molar amounts of the two reactants. Infrared spectra from these three combinations of reactant solutions are shown in “stacked” fashion in FIG. 7.

Other than evident formation of polyurea products, the most notable finding from comparison of these spectra is that the “equi-molar” mixture actually had an excess of isocyanate. This is visible by comparison of the peak intensities at 2268 cm⁻¹ for the three combinations of reactants. This peak in the spectrum is assigned to stretching of the isocyanate group (—N═C═O). This peak should not be present in the spectrum generated for excess amine, nor should it be present in the spectrum generated by mixtures in which all of both reactants are consumed to form product, that is from equi-molar mixtures of the two reactants. Given that reactant purities were initially no higher than about 98% and the small volumes of material used in these early tests, exact matching of molar quantities for the two reactants was understandably not achieved.

Formation of polyurea was clear in all three cases, as indicated by the strong carbonyl stretches due to Amide I (1634 cm⁻¹) and Amide II (1554 cm⁻¹ and 1510 cm⁻¹) coupling vibrations. In addition to this, the strong, broad peak at 3294 cm⁻¹ was due to hydrogen-bond associated N—H stretching. The lack of a sharp peak at 3450 cm⁻¹, which would be due to freely stretching N—H, is predictable since virtually none of these would be present in polymers so strongly bound together by hydrogen bonds. It is not expected that the bi-dentate hydrogen-bond structure would have formed efficiently in these mixtures, since they were solution-mixed in test tubes, with turbulent stirring and shaking. The tendency of such structures would be increased by proper alignment of the polymer chains drawn in tension, as when a fiber is pulled or spun concomitant with the chemical reaction.

Molecular modeling of potential resonance vibrations through the urea linkage indicated a number of long-range coupling scenarios are feasible within the para-para polyurea material. Many of these are complex vibrations involving different combinations of torsional, or wagging motions of the nitrogen-carbonyl-nitrogen system coupled with various vibrations in the benzene rings. All are low-frequency and assignable to the diminishing cascade of peaks in the spectrum between 1300 cm⁻¹ and 900 cm⁻¹.

### Example 3

### Differential Scanning calorimetry Analysis of Reactant Solutions

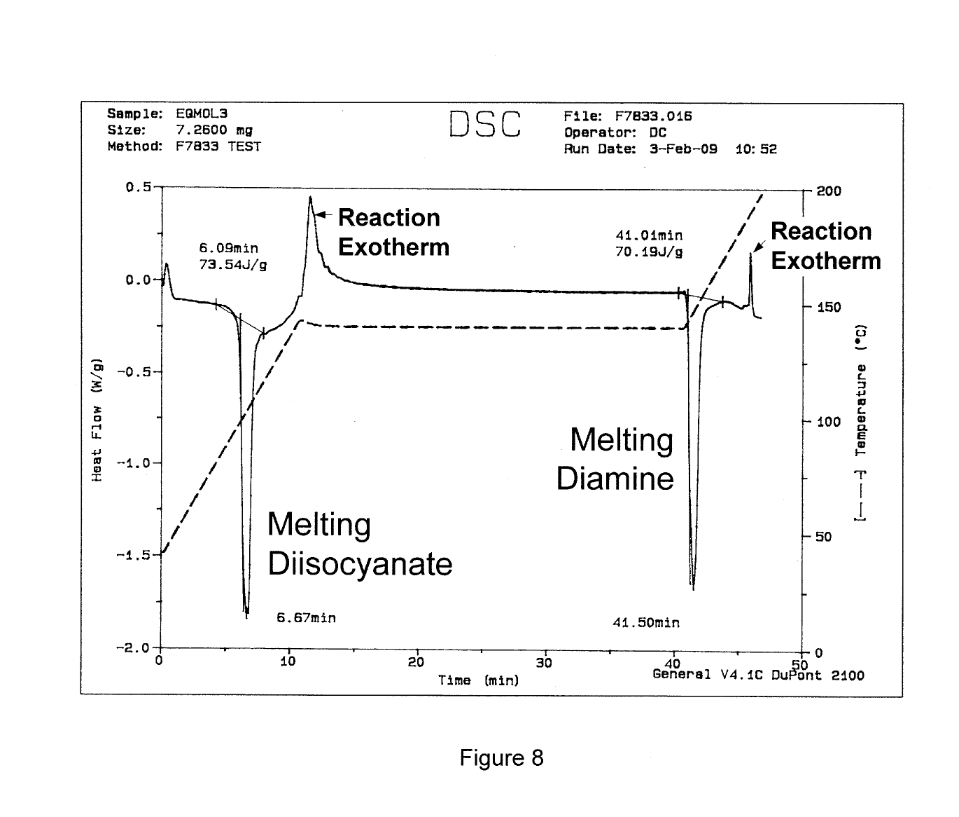

Early investigations involved differential scanning calorimetry on mixtures of finely ground powders of the reactants. One scan obtained from these activities merits discussion, shown in FIG. 8. In this case, the reactants were finely ground, mixed in equi-molar proportion in an agate mortar with a pestle, and a small mass of the mixtures sealed in a hermetic differential scanning calorimetry (DSC) pan. The temperature was ramped at 10 C/minute to 140° C., held for 30 minutes at this level, and then ramped to 200° C.

In FIG. 8, the two large, sharp, negatively directed peaks represent the endotherm traces of melting paraphenylenediisocyante and paraphenylenediamine at about 6 minutes and 41 minutes, respectively. For the time between 11 and 40 minutes, the temperature was held constant, above the melting point of the diisocyante. At the beginning of this temperature plateau, a minor exotherm occurred (˜13 minutes). It was tempting to think this was due to diisocyanate reaction with the diamine. However, if this was the case, then no subsequent fusion of the diamine would have occurred, and the endotherm at 41 minutes would not have been present. Melting of the diamine at about 150° C. would have resulted in a molten mass of the two reactants in the hermetic pan, and this could have led to chemical reaction of the two components. However, again only a minor exotherm peak is evident at about 47 minutes (corresponding to a temperature near 180° C.). It was suspected, without further inquiry, that the two liquid reactants were only partially miscible in one another, and this inhibited the reaction from proceeding. On the other hand, interfacial reaction of the two chemical components could have formed an impermeable barrier between them, which resisted heat in the range of temperatures used in this particular experiment.

### Example 4

### Solvent Choice for Synthesis Reaction

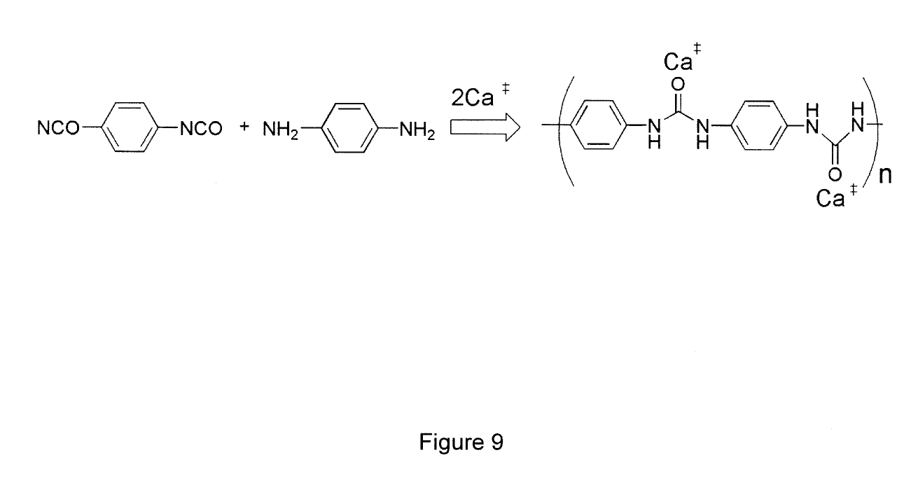

Other initial, small-scale experiments showed that the product immediately precipitates in dichloromethane and p-dioxane, which quickly became early solvents of choice for these reactions. Investigations of the literature suggested that the solubility of the polymer product could be increased with a hydrogen bonding blocking agent, such as CaCl₂, dissolved in the solvent medium before the reactants were combined. This concept is summarized in FIG. 9.

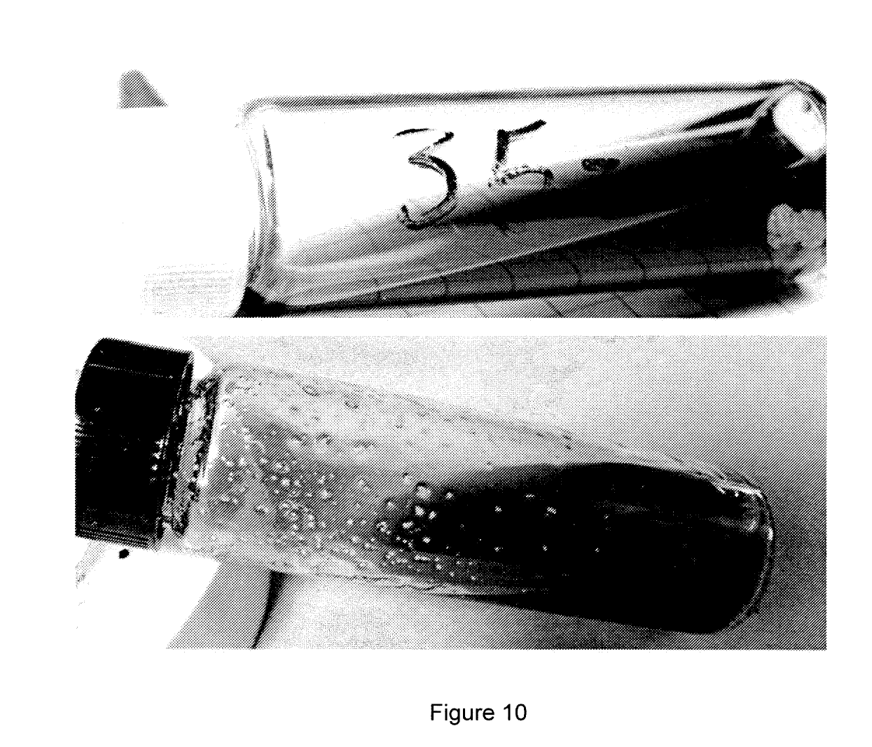

Initial trials in n-methylpyrrolidone indicated this approach allowed the production of dark brown to amber, clear, viscous solutions and gels. Examples are shown in FIG. 10.

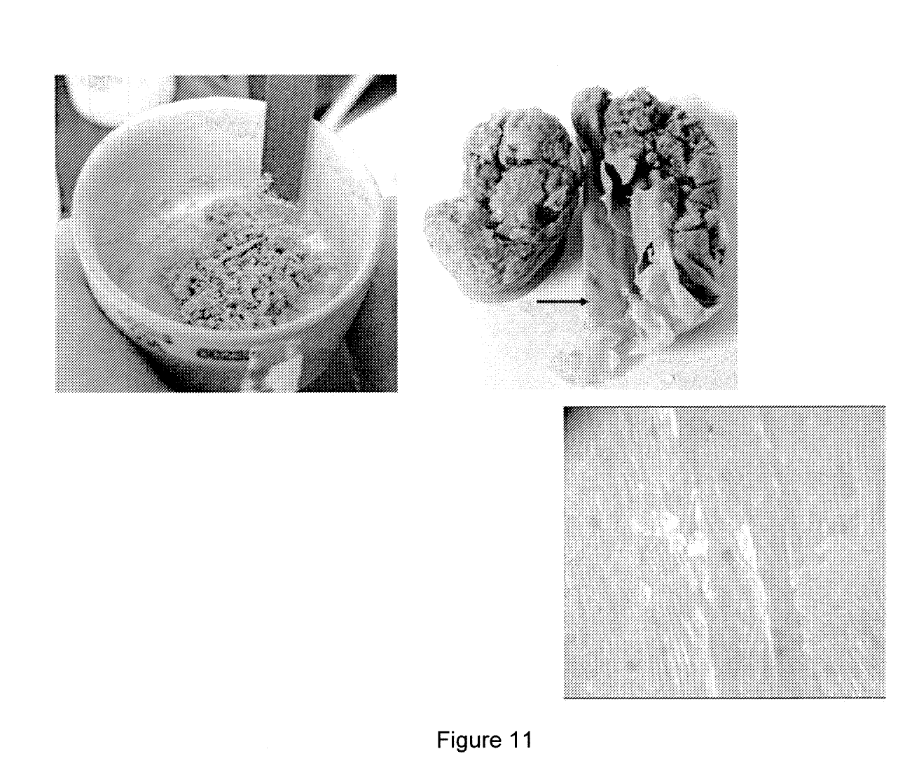

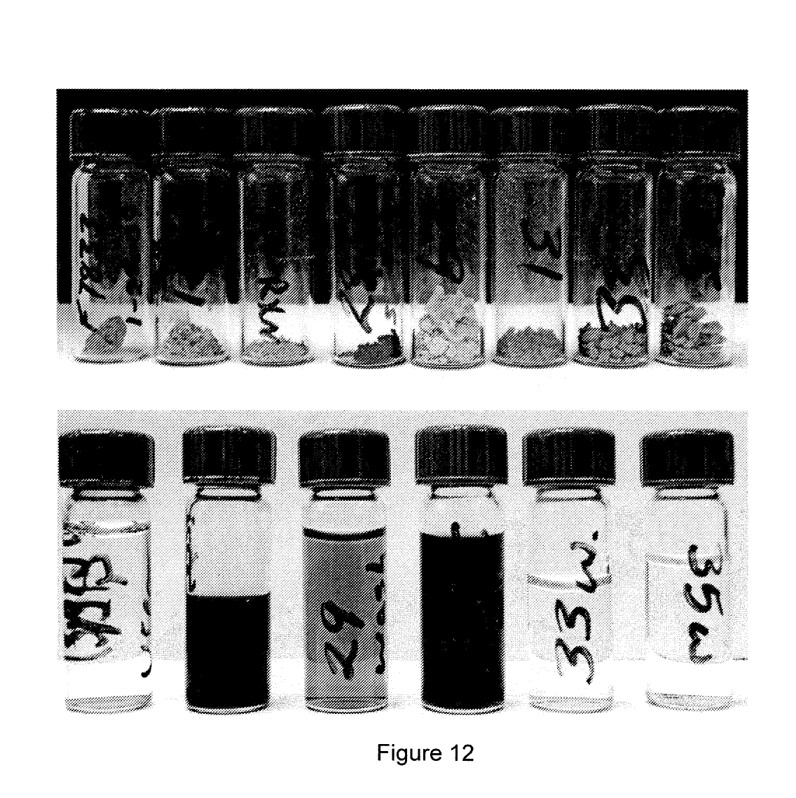

When water was added to these gels, either fine precipitates or gelatinous masses formed, depending upon the rate of addition. When the reaction product mixtures was quenched in water too quickly, a gelatinous mass formed, shown in FIG. 11. The image on the left in this figure is of a fine, moist precipitate, which resulted from slower quenching in de-ionized water. Other examples of finely divided product precipitate, and the resulting quench media, are shown in FIG. 12 to illustrate the range of colors and particulate compositions achieved in these initial “hand mixed” experiments.

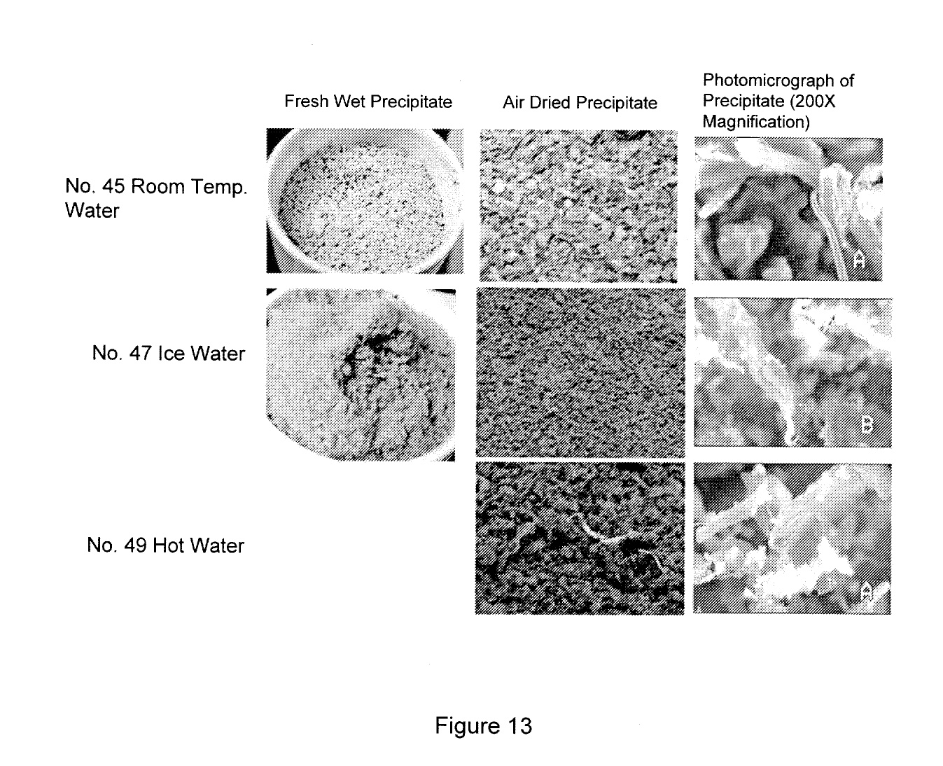

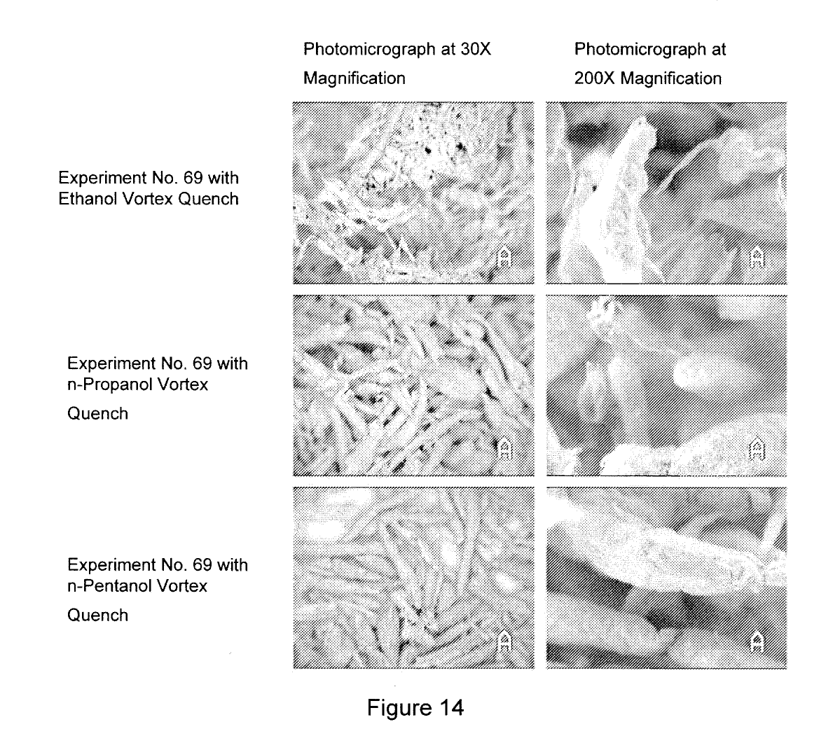

Visual inspection of the gelatinous mass shown in the center image of FIG. 14 suggested a fine fibrous structure was present in this part of the product. This had formed as a film on the internal wall of the mix vessel when water was added to quench the reaction. The fibrous structure was confirmed on closer inspection at 200× magnification with a digital microscope. The image on the right of FIG. 11 is shown to illustrate this structure. The arrow in the center image indicates the approximate location where the higher magnification image was obtained. These observations suggested that the fiber character of the precipitate might be increased by more slowly quenching the reaction solution in a water vortex. This was performed for the next series of reactions (number 45, 47, and 49) and the results are shown visually in FIG. 13 and FIG. 14. It was hypothesized that the temperature of the quench water could affect the size or aspect ratio of precipitate particles. Reaction number 45 was quenched at room temperature; reaction number 47 was quenched in ice water; reaction number 49 was quenched in nearly boiling water.

Without wishing to be bound by theory, it may be that upon exposure to water during the quench process, calcium ions are solvated and removed from their chelation positions along the polymer chain at carbonyl groups. This may allow amine hydrogens on adjacent chains to bond with the carbonyl oxygens causing the polymer to condense. Thus, quenching removes the blocking effect of calcium ions and the resultant, hydrogen-bonded polymer is not soluble in the resulting solvent mixture.

Visual appearance of the precipitates in FIG. 13 appeared to indicate that temperature could affect the fiber yield of the product, but the high degree of variability in the results made it difficult to see any trends. With this in mind, a series of the investigations was conducted to slow the quench reaction. First, ethanol was substituted for water. This was followed consecutively by other quenches in homologous alcohols, including n-propanol, n-butanol, and n-pentanol. In general, a significant increase in the fiber fraction of the precipitate was found between quenches in water and in alcohol. However, quenches in the various alcohols showed markedly less variation between them. These results are shown in FIG. 14.

Sample 55 was synthesized following R. J. Gayman's protocol (No. 18, see below) with the following exceptions. The reaction was stirred with a vibrating agitator, the second component was dissolved in NMP and then added instead of being added in molten liquid form, the reaction started at room temperature and the temperature was allowed to rise naturally and the polymer was precipitated with EtOH instead of H₂O. Gayman produced a polyaramid that he described as “a crumbled mass.” On the other hand, the product produced by the currently disclosed process was a viscous fluid. Since the aromatic polyurea product of the currently disclosed product should theoretically be crystalline and have a higher degree of hydrogen bonding, the physical difference between the viscous solution taught here and the teaching of Gayman is related to the difference in molecular weight of the products. The reaction in Gayman's protocol No. 18 may be kinetically more vigorous than the currently disclosed reaction. Sample 69 is made in the same manner as Sample 55, except that the mixing was done using a rotating carousel.
Synthesis following Gayman's protocol No. 18: To a small glass vial, 1.4177 g of finely ground and dried calcium chloride suspended in 5.8959 g of N-methyl pyrrolidone (24 percent by weight calcium chloride) is added. The calcium chloride is partially present in the solid state. To this suspension, 0.4307 g of powdered p-phenylene diamine is added with stirring. Subsequently, 0.6373 g of p-phenylene diisocyanate dissolved in 5.8984 g of N-methylpyrrolidone is added rapidly. Stirring is continued for 30 minutes while the temperature rises. A viscous solution is formed which contains 1.068 g of poly(p-phenyleneurea) (9 percent by weight). A suspension of the polymer is obtained by precipitation with ethanol under a vigorous vortex. Following filtration, washing and drying, a poly-p-phenyleneurea is obtained.

Sample 79 was made differently from sample 55, based on dilution of the reactants prior to mixing. The molar ratio of CaCl₂ to polyurea is lower in sample 79 as compared to sample 55. Also, the diamine in sample 79 is dissolved in a larger portion of the total NMP due to its lower solubility compared to the diisocyante. This sample was also mixed on a carousel.

Comparison of the images in FIG. 13 and FIG. 14 show a remarkable increase in the fiber fraction of the precipitate. Interestingly, it appears that of the three alcohols, an ethanol quench resulted in a higher fraction of the finer fibers than in propanol and pentanol. The stark differences in precipitate compositions obtained with water and alcohol quenches was likely due to the differences in solubility of calcium ion in these different media. However, this solubility difference was less between the higher homologous alcohols (propanol and pentanol), hence the similar pulpy appearances of the precipitates obtained from propanol and pentanol quenches.

### Example 5

### Fiber Drawing of the Aromatic Polyurea

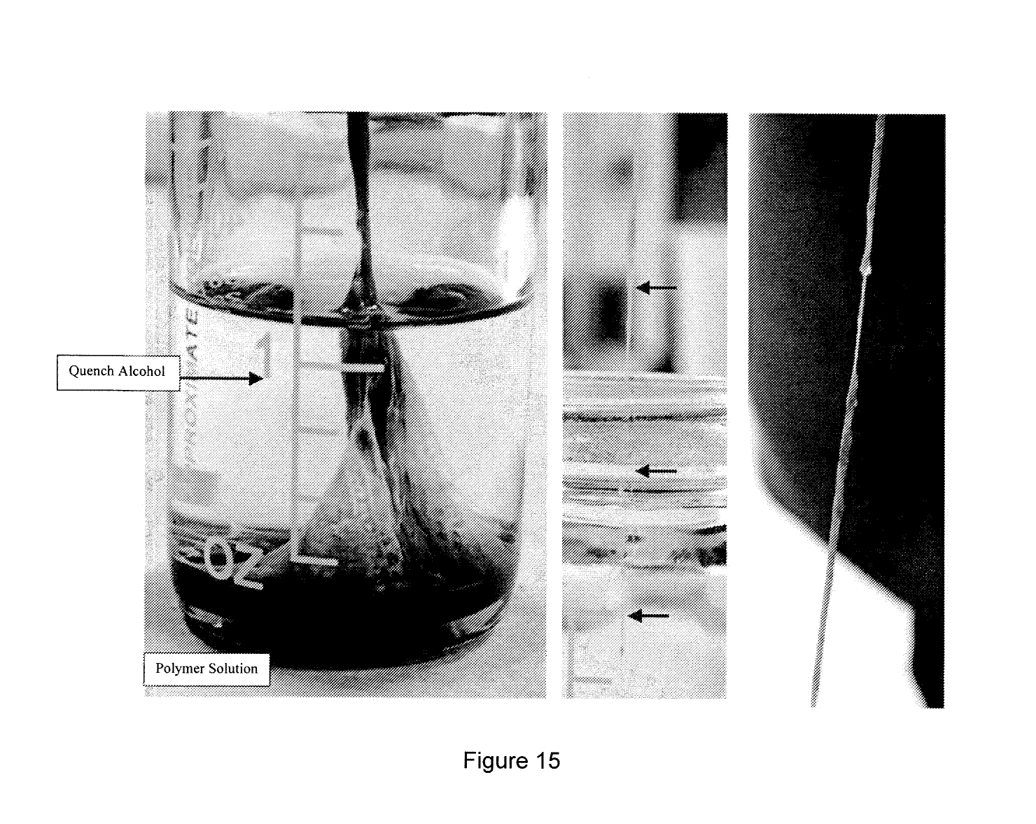

Quenching with a vortexing medium having a lower dipole moment than that of water resulted in the most fibrous precipitate observed at this point in the project. Without wishing to be bound by theory, it appears that shear force imparted by the vortex on the polymer to align its chain was nearly balanced with calcium removal from carbonyl groups along the chain. Considering these results, an attempt was made to draw the fiber. In this trial, a small portion of the polymer solutions was covered by a thick layer of ethanol. Using a hooked probe, a small portion of the interface between the solution and ethanol was drawn slowly from the vessel. This resulted in a fiber mass being drawn from the vessel as shown in FIG. 15.

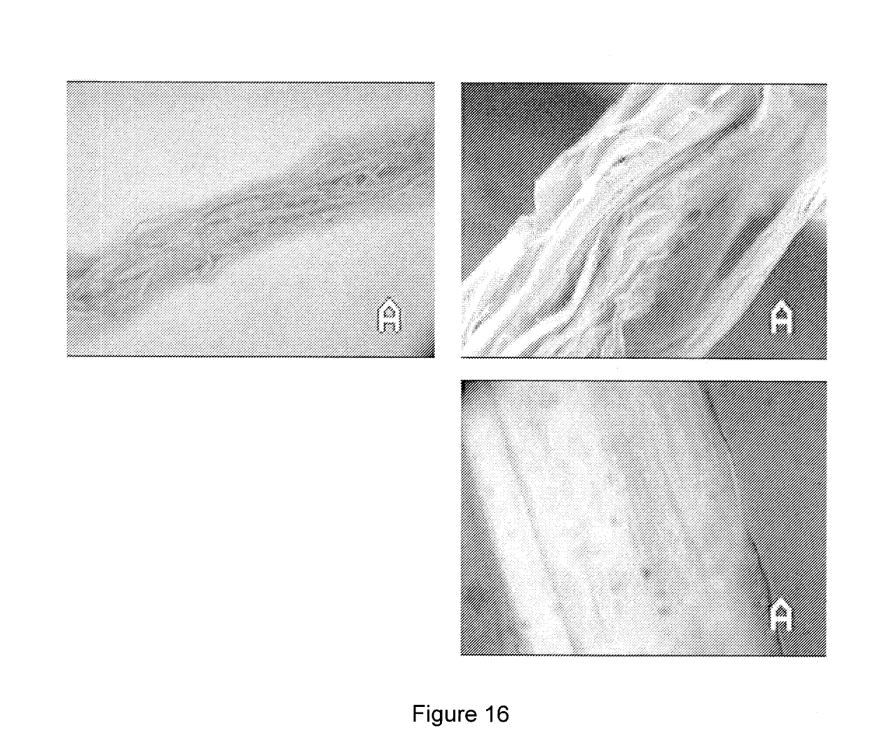

After allowing this fiber to dry overnight in room conditions, photomicrographs were obtained from several segments to view its structure. In FIG. 16 these are shown at three magnifications. Clearly this fiber is far from the dimensional homogeneity found in commercial fibers, but it does demonstrate that the conditions necessary to draw fibers from the polymer in its current state are readily achievable. Also, it shows that sufficient polymer molecular weight has been obtained by the current synthetic process to draw fibers.

### Example 6

### Synthesis of Aromatic Polyurea Fiber

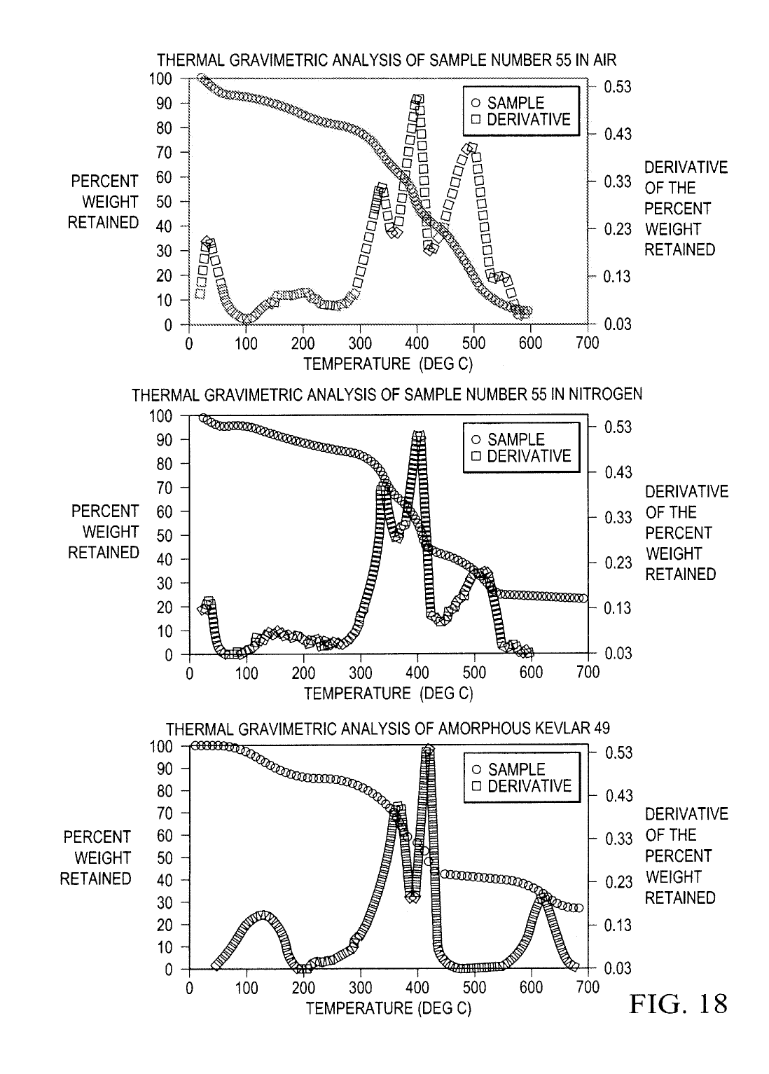

Aromatic polyurea fiber was prepared as follows:
I. Preparing reactant solutions:
   1a. To a clean vial, add 23.4% by weight of purified paraphenylene-diisocyanate (PPDI) in anhydrous N-methyl-2-pyrrolidone (NMP).
   2a. Shake resulting mixture vigorously until the isocyanate is dissolved (colorless, transparent, low viscosity liquid).
   1b. To a clean reaction vessel, add ground 7.5% by weight of para-phenylenediamine (PPDA) in anhydrous NMP.
   2b. Cover vessel in foil to reduce UV exposure. Shake vigorously until dissolved (4-5 minutes) The resultant solution should be a light pink transparent fluid.
   3b. Add 17.6% by weight, based on NMP, of completely dehydrated CaCl₂ to the vessel from 2b above. Shake until suspension is formed (5 minutes). Should turn light brown and retain low viscosity.
II. Combination of reactant solutions to form polymer product:
   1. Add solution A to reaction vessel B mixing vigorously until a noticeable change in viscosity is observed, followed by gentle end over end mixing on a carousel (see FIG. 18) to maintain suspension of CaCl₂.
   2. Dilute product solution with NMP to desired viscosity of concentration. Theoretical concentration by this method is expected to be 12.6% by weight of product in NMP.
III. Isolation of polymer product:
   1. In great excess (40×) of anyhydrous ethanol at room temperature, create a swirling vortex.
   2. Steadily stream in product solution to the ethanol bath, and wash thoroughly.
   3. Filter the precipitate until dry in a Buchner funnel (shown previously in FIG. 7), followed by a short rinse with acetone to dry further.
   4. Collect product and place in oven at 110° C. until dry.

Table 3 provides a summary of the key polymer compositions, experimental conditions, and general results obtained after the decision to use n-methylpyrrolidone as the carrier medium and calcium chloride as the stabilizer for synthesis reactions. Table 3 is organized according to experimental sequence number in the left hand column. The second and third columns give the concentrations of diisocyanate and diamine in total n-methylpyrrolidone. Similarly, the fourth column gives the expected concentration of polymer product in the final mixture, and the fifth gives the percent excess calcium chloride. The sixth column shows the reaction temperature used when the two component solutions were mixed to form product. Visual observations on the product solution are given in the seventh column; the quench conditions are given in the eighth.

Without wishing to be bound by theory, it has been observed in the experiments reported herein that increases in molecular weight of the product may be achieved by retaining the product in solution as long as possible, slowing the addition rate of diisocyante to the solution of product and unreacted diamine, and modest, but continuous vortex mixing of the reaction medium. It appears important to ensure greater than 99% purity of the reactants and n-methylpyrrolidone, and to ensure anyhydrous conditions are maintained with respect to this solvent and the calcium chloride.

TABLE 3
Summary of Solution-Based Synthesis Investigations.

| Exp. | % | % | % | % | Rxn | Viscos Consistency | | |
|---|---|---|---|---|---|---|---|---|
| # | PPDI | PPDA | Polyurea | CaCl2 | temp | of Product Soln | Quench Solvent | General Notes |
| 15 | 5.32 | 3.71 | 9.02 | 11.77 | 0° C. | molasses | water (non-vortex @ RT) | first CaCl₂ test |
| 21 | 5.40 | 3.59 | 8.99 | 11.66 | 0° C. | honey | water (non-vortex @ RT) | repeat of 15 |
| 23 | 2.71 | 1.82 | 4.53 | 6.00 | 0° C. | water thin | water (non-vortex @ RT) | CaCl₂ in both sides |
| 25 | 5.54 | 3.70 | 9.23 | 11.67 | 0° C. | sold gel | water (non-vortex @ RT) | KBr used instead of CaCl₂ |
| 29 | 5.50 | 3.64 | 9.14 | 11.97 | 0° C. | molasses | water (non-vortex @ RT) | CaCl₂ on amine side |
| 31 | 5.50 | 3.66 | 9.16 | 11.74 | 0° C. | honey | water (non-vortex @ RT) | CaCl₂ on both sides |
| 33 | 5.50 | 3.65 | 9.15 | 11.86 | 0° C. | honey | water (non-vortex @ RT) | chelating 2.5% done |
| | | | | | | | | (2,4-pentanedione) |
| 35 | 5.51 | 3.64 | 9.15 | 11.70 | | honey | water (non-vortex @ RT) | chelating 2.5% dione |
| 37 | 5.41 | 3.70 | 9.11 | | 0° C. | crashed out | water (non-vortex @ RT) | chelating 2.5% dione (no CaCl₂) |
| 41 | 5.41 | 3.63 | 9.04 | 12.07 | RT | molasses | water (non-vortex @ RT) | first RT reaction |
| 43 | 5.42 | 3.65 | 9.07 | 11.61 | 0° C. | @ 10 min. solid gel | water (non-vortex @ RT) | 1 of 4 repeatability study (cold) |
| 45 | 5.37 | 3.63 | 9.00 | 11.77 | 0° C. | @ 10 min. molasses thick | water (vortex @ RT) | 2 of 4 repeatabrlity study (cold) |
| 47 | 5.41 | 3.66 | 9.07 | 12.00 | 0° C. | @ 10 min. near gelled | water (vortex @ 0C) | 3 of 4 repeatability study (cold) |
| 49 | 5.41 | 3.65 | 9.06 | 12.07 | 0° C. | @ 5 min. near gelled | water (vortex @ 100C) | 4 of 4 repeatability study (cold) |
| 51 | 5.40 | 3.65 | 9.05 | 12.10 | RT | @ 15 min. honey | 1-propanol (vortex @ RT) | 1 of 4 repeatability study (RT) |
| 53 | 5.41 | 3.66 | 9.07 | 11.84 | RT | @ 15 min. honey | water (vortex @ RT) | 2 of 4 repeatability study (RT) |
| 55 | 5.40 | 3.65 | 9.06 | 12.02 | RT | @ 5 min. honey | EtOH (vortex @ RT) | 3 of 4 repeatability study (RT) |
| 57a | 5.41 | 3.65 | 9.06 | 11.83 | RT | @ 5 min. honey | EtOH (vortex @ RT) | 4 of 4 repeatability study (RT) |
| 57b | | | | | RT | @ 5 min. honey | EtOH (vortex @ RT) | needle IN solvent “coagulated” |
| 57c | | | | | RT | @ 5 min. honey | EtOH (vortex @ RT) | needle as close as possible to vortex |
| 63 | 5.40 | 3.64 | 9.04 | 11.83 | RT | @ 5 min. honey | n-Butanol vortex @ RT) | supernatant is bright yellow |
| 65 | 5.36 | 3.61 | 8.97 | 11.79 | RT | @ 5 min. honey | Pentanol (vortex @ RT) | supernatant is bright yellow |
| 69a | 5.40 | 3.66 | 9.05 | 12.00 | RT | @ 5 min. honey | EtOH (vortex @ RT) | first carousel experiment |
| | | | | | | | | (repeated since) |
| 69b | | | | | RT | @ 5 min. honey | Propanol (vortex @ RT) | |
| 69c | | | | | RT | @ 5 mm. honey | Pentanol (vortex @ RT) | |
| 71 | 5.40 | 3.65 | 9.06 | 11.88 | 0° C. | @ 5 min. honey | EtOH (vortex @ RT) | repeat cold on carousel |
| 73 | 5.45 | 3.66 | 9.11 | 11.65 | 80° C. | solid gel | EtOH (vortex + blender @ RT) | hot reaction on carousel |
| 75 | 5.39 | 3.64 | 9.03 | 12.12 | RT | @ 5 min. honey | films quenched in EtOH | new NMP bottle henceforth |
| 77 | 5.42 | 3.66 | 9.08 | 12.01 | RT | @ 5 min. honev | films quenched in EtOH | scale up reaction |
| 79 | 7.52 | 5.10 | 12.63 | 11.97 | RT | @ 5 min. honey | films quenched in EtOH | disproportionate reactants |
| 81 | 5.40 | 3.65 | 9.05 | 12.17 | RT | gray rubbery mass | was not precipitated from soln. | THF exploratory |

### Example 7

### First Alternative Method for Synthesis of Aromatic Polyurea Fiber

To test the effect of constant and thorough mixing on the resultant product solutions, an alternative method to the method provided in Example 4 was carried out.

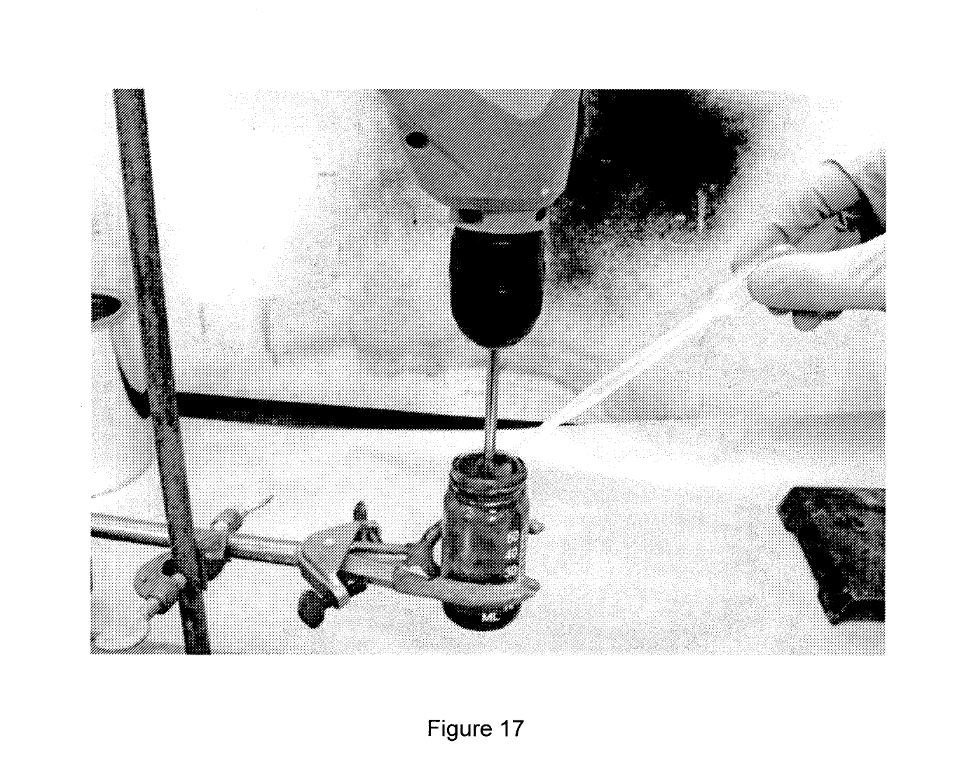

In the first alternative method, experiment number 87, a “Drink Master” electric blender was used to induce a higher energy vortex than any earlier experimental procedure. All reactants were added drop-wise in the quantities described in Example 4, and after fifteen minutes a highly coagulated product resulted. At this point 50% more n-methylpyrrolidone was added to dilute the product solution so that the material could be poured or transferred. Even this solution was considered quite viscous after that dilution. In the final moments of mixing the mixer motor failed due to the highly viscous solution. A higher-power, handheld mixing drill was used to repeat the procedure with sample 93 as shown in FIG. 17.

### Example 8

### Second Alternative Method for Synthesis of Aromatic Polyurea Fiber

A second alternative method to the method provided in Example 4 was carried out.

The second alternative method, experiment number 89, involved initial dilution of the para-phenylenediamine in an effort to make subsequent dilution at the end of polymerization unnecessary. Because of the additional solvent, the reaction was easily mixable at higher energy for a longer time. However, the solution never became as viscous as in experiment number 87. This experimental procedure was repeated to ensure validity (sample 91).

Upon repeating the two alternative methods described in Example 5 and Example 6 (experiment numbers 91 and 93, respectively) two solutions that only differed in the dilution protocol were obtained. These experiments resulted in a viscosity difference between the two product solutions of approximately 8000 centi-Poise, suggesting a higher molecular weight for the first reaction was obtained (where the reactants were present at a greater mass concentration, compared to n-methyl-pyrrolidone). Thus, the amount of solvent present during initial stages of reaction has a direct effect on the viscosity and hence apparent molecular weight of the final product.

### Example 9

### Properties of the Aromatic Polyurea Fiber

The polymeric product obtained from experimental trial number 55 (see Table 3) was subjected to thermal gravimetric analysis (TGA). TGA measures and tracks weight loss as the temperature of the sample is raised. The weight loss scale in plots of these analyses starts at 100% since the material does not decompose and begin to lose weight until higher temperatures are reached. Thus, as temperature increases, the percent remaining material decreases. This can be seen from the trace labeled “sample”, indicated by the decreasing curves in the plots of FIG. 18.

Sudden changes in slope of these curves represent the onset of new thermal regimes that are more thermally stable than material evaporated at lower temperatures. Sample number 55, run in air (FIG. 18, top) exhibited no less than six changes in slope of the weight loss curve, as demonstrated by the plot of its derivative, marked by the trace labeled “derivative.” The first of these “steps” represented evaporation of attached, residual water; the second, loss of n-methylpyrrolidone, which was used as the solvent in synthesis of this particular polymer. Together, water and NMP represented over 20% of the weight of the sample. The largest drops in sample weight occurred above 300° C., consecutively losing about 15%, 20% and then 30% of the sample through heat and evaporation. These evidently represent decomposition of the polymer itself, and suggest three different fractions of polymer were present in the product sample. Above 500° C., the sample continued to lose weight as temperature increased, until it leveled off with about 5% char residue at 600° C.

The analysis was repeated in a nitrogen atmosphere with a second sample of experiment number 55 to determine the extent air oxidation played in this thermal decomposition. The general patterns of the weight loss and derivative traces was the same as that obtained in air, except about 25% char residue was obtained above 600° C. (see middle plot, FIG. 18). Evidently, the aromatic polyurea fiber composition disclosed herein is oxidatively stable until 600° C., above which temperature most of the residue oxidizes and evaporates.

The same analysis was repeated with Kevlar 49® (poly paraphenylene terephthalamide). As expected, there was little evidence of thermal decompositional weight loss until temperatures above 400° C. were reached, and then weight loss was sudden and immediate. At temperatures above 600° C., approximately 20% char residue remained, when the analysis was done in nitrogen. Evidently, much of this high thermal stability in Kevlar 49® was due to the high crystallinity of the drawn fiber used to make the sample. With this in mind, the analysis was repeated with less crystalline Kevlar®, so that the results would be more reflective of the process history experienced by the aromatic polyurea fiber disclosed herein (sample 55). That is, the fiber disclosed herein had not been spun-drawn and thermally tensioned to optimize degree of crystallinity and thermal-physical properties, as had the Kevlar®. A sample of Kevlar 49® was dissolved in hot high-purity 99% sulfuric acid, followed by slow quenching in vortexing, room temperature water. The resultant fibrous mass was air dried over night and then oven dried at 100° C. for 24 hours. A sample of this post-processed, para-crystalline Kevlar 49 was then analyzed using the same thermal gravimetric procedure as above. The plotted result of the analysis in nitrogen is shown at the bottom of FIG. 18. Again, below 200° C. the traces represent loss of residual water and possibly gaseous SO₂ from residual sulfuric acid. Most of the polymer decomposition occurred above 300° C., as with sample number 55 of the currently disclosed aromatic polyurea fiber; and the general patterns of the thermal decomposition weight loss in the two materials were roughly similar between 300° C. and 450° C. Two distinctions were evident between the plots from para-crystalline Kevlar 49 and the currently disclosed aromatic polyurea fiber from experimental synthesis number 55. These are seen in the different peaks in derivative spectra above 450° C. Para-crystalline Kevlar 49® demonstrated a rough, skewed weight loss that peaked at about 520° C. It is possible these represent near-char residues from the two materials, which are chemically different, because of the amide and urea linkage in the starting materials of the two samples at the beginning of each analysis.

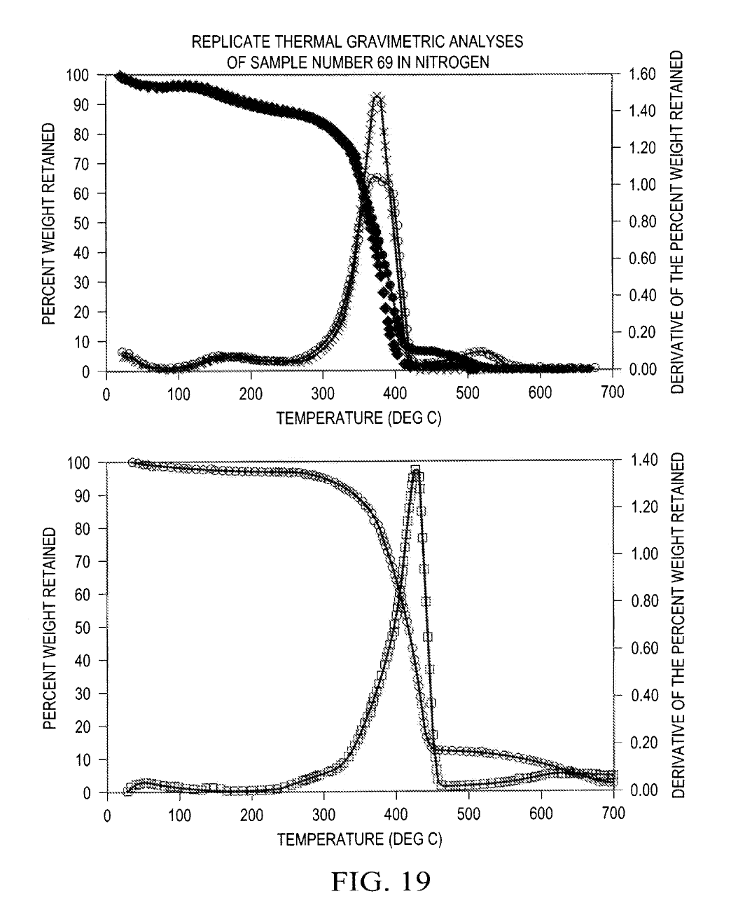

Continued investigations, after synthesis of number 55 described above, were focused on increasing molecular weight of the polyurea product. Thermal analysis of the two of these experiments, number 69 and number 73, are plotted in FIG. 19. The most notable distinction between the two plots in FIG. 19 and the plots in FIG. 18 of embodiments of the present invention is that the earlier consecutive, step-wise decomposition has collapsed to nearly a single decomposition step above 350° C. The analysis was conducted twice from samples of experiment number 69, as shown by the two, nearly overlapping blue weight loss traces in the plot, together with their corresponding derivatives shown in red. Both of these analyses indicated an onset of thermal decomposition for number 69 at about 320° C., which peaked in intensity at 380° C. Subsequent attempts to increase molecular weight of the aromatic polyurea fiber material resulted in concomitant increases in thermal stability for experiment number 73. For this later polymer, thermal decomposition began at about 350° C. and peaked at nearly 430° C.

Following the thermal analytical assessments on fibrous precipitates described above, we next considered drawn films of the polymer product. In these cases sample films were prepared by drawing a metered edge over the product solution (in NMP) after it was poured onto a clean glass plate. The metered edge ensured a uniform thickness of solution was obtained on the glass. Afterward, the glass and polymer solution film were gently submerged in an alcohol (e.g., ethanol, n-propanol) to dissolve and remove calcium ions and the NMP. This resulted in gelation of the polymer. Gentle swirling of this combination was continued until the gelled film detached from the glass plate. Following this, the film was consecutively air dried at room temperature for 12 to 24 hours, and then at 100° C. overnight. The resultant film was brittle and variously warped due to shrinkage.

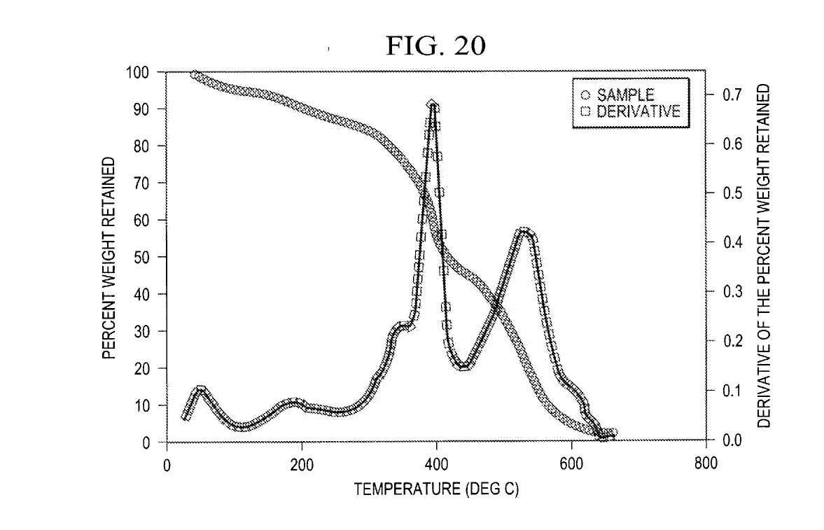

Several samples of these films were sent for structural analysis, and one sample (experiment number 79) was assessed for thermal stability by thermal gravimetric analysis. Again, residual solvent loss was observed below 230° C. However, above this temperature four sizable polymer fractions were evident from significant drops in sample mass at about 330° C., 390° C., 530° C., and 600° C. Little or no residual char remained at temperatures above 625° C. Drawing the metered edge to obtain uniform solution film thickness on the glass plate will tend to align polymer molecules in the solution. Once the metered edge passes over a particular polymer molecule it may retract to various extents, depending upon its internal tendency to coil up on itself; but this will tend to decrease with higher and higher molecular weight polymers, as a result of dispersive attractive forces between adjacent chains. Nevertheless, the pattern observed for sample number 79 in FIG. 20 is notably different from the precipitated sample results described earlier with reference to FIG. 18 and FIG. 19, and this may be due to the different methods of their preparation, or differences in their molecular weight distributions.

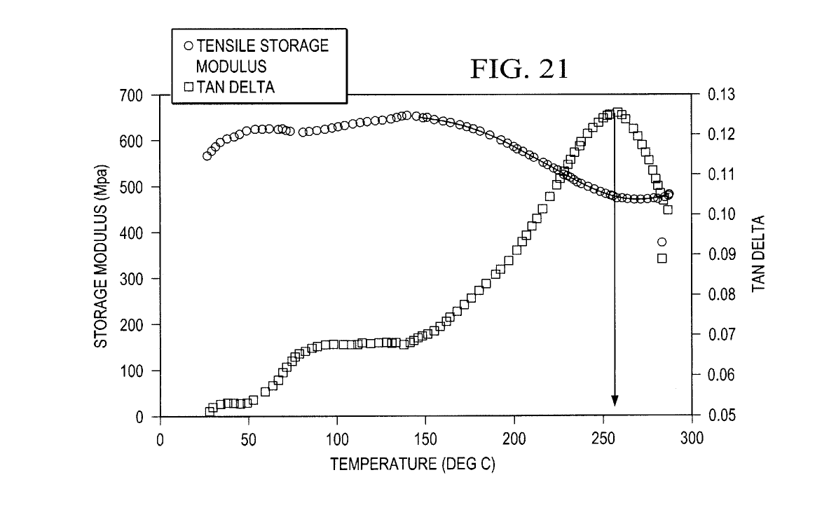

Dynamic mechanical analysis was next performed on a sample film obtained from experiment number 79. A straight break occurred when the sample failed at about 285° C. This analysis held the sample in tension, and 1 Hz frequency was used. The plotted results of measurements of storage modulus and tan delta up to the failure temperature of the sample are shown in FIG. 21. The “Tensile Storage Modulus” plot shows a relative constant value of storage modulus, near about 600 MPa, until the sample reached temperatures above 170° C. Consecutively higher temperatures resulted in a monotonic decrease in storage modulus, down to about 450 MPa. The peak in the “Tan Delta” trace suggests the glass transition temperature (Tg) was about 255° C. for sample number 79.

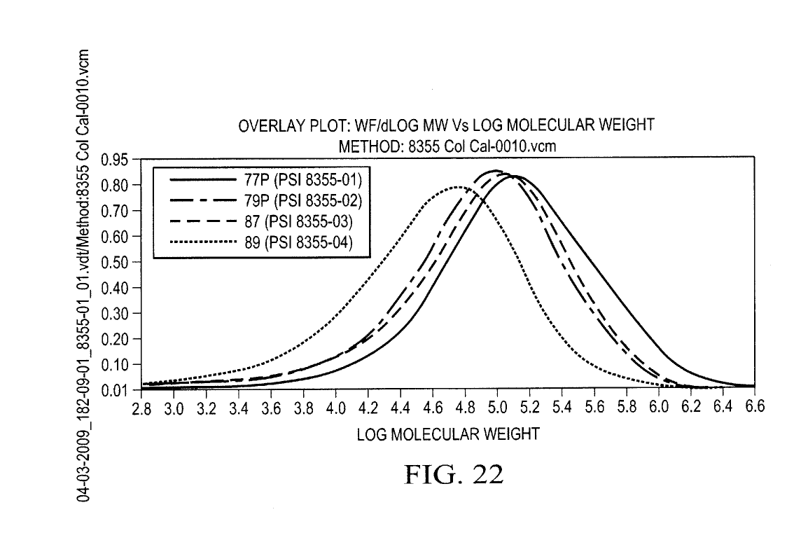

Molecular weights of selected experimental polyureas in NMP solution were sent to Polymer Solutions, Inc. There, the molecular weights were measured using gel permeation chromatography against a polystyrene standard. The numerical results are summarized in Table 4. Plots of the data exhibited near normal distributions, with slight skewing toward lower weights (see FIG. 22).

TABLE 4
Summary Table of GPC Molecular Weight Data
taken from Polymer Solutions, Inc. Report
No. 6776 (see Table 2.3.2 for reference).

| TRI Sample | Replicate | Molecular Weight Averages (g/mol) | | | |
|---|---|---|---|---|---|
| Identification | Sample | Mₙ | M_{w} | M_{z} | M_{w}/Mₙ |
| 77P | 1 | 44,754 | 228,759 | 638,530 | 5.11 |
| | 2 | 50,480 | 228,746 | 627,864 | 4.53 |
| | Average | 47,617 | 228,753 | 633,197 | 4.82 |
| | Std. Dev. | 4,049 | 9 | 7,542 | 0.41 |
| 79P | 1 | 24,704 | 135,514 | 334,154 | 5.49 |
| | 2 | 24,300 | 135,307 | 329,095 | 5.57 |
| | Average | 24,502 | 135,411 | 331,625 | 5.53 |
| | Std. Dev. | 286 | 146 | 3,577 | 0.06 |
| 87 | 1 | 26,467 | 150,240 | 373,867 | 5.68 |
| | 2 | 25,144 | 151,670 | 393,795 | 6.03 |
| | Average | 25,806 | 150,955 | 383,831 | 5.85 |
| | Std. Dev. | 936 | 1,011 | 14,091 | 0.25 |
| 89 | 1 | 13,761 | 84,402 | 357,354 | 6.13 |
| | 2 | 12,904 | 81,915 | 334,292 | 6.35 |
| | Average | 13,333 | 83,159 | 345,823 | 6.24 |
| | Std. Dev. | 606 | 1,759 | 16,307 | 0.15 |

In Table 4 Mₙ is the number-averaged molecular weight, M_{w} is the weight averaged molecular weight and M_{w}/Mₙ is a measure of the spread in the distribution, known as its polydispersity. According to Billmeyer (1984), number averaged molecular weights of commercial polymers lie in the range 10,000 to 100,000, and in most cases, the physical properties associated with typical high polymers are not well developed if Mₙ is below about 10,000.

Interestingly, the values of polydispersity shown in Table 4 lie in the range of polymers synthesized by an autoacceleration route, such as a free radical mechanism. These are usually characterized by an increase in reaction rate with molecular weight, known as the gel effect, and this occurs when the rate limitation results from diffusion of the polymer in a viscous medium. While we do not believe the mechanism of the current polyurea forming reaction proceeds by free radical polymerization, the product solutions do become increasingly viscous over time. Without wishing to be bound by theory, it is very possible that a high degree of hydrogen bonding between the tertiary amine of the solvent (NMP) and nitrogen protons on the polymer backbone is responsible for our observed increases in viscosity, and this leads to characteristics of autoacceleration, which may be misleading in terms of the chemical mechanism.

When samples were sent to Polymer Solutions, Inc. for molecular weight measurements, they were kept suspended in solution and stabilized with calcium chloride. Samples were only diluted with additional NMP to approximately 4% by weight of product. The molecular weights reported above in Table 4 and FIG. 22 include the mass of calcium ions chelated to the polymer backbone through the carbonyl oxygen. Thus, these molecular weights require downward adjustment by a factor representative of the amount of calcium attached to the polymer backbone. Since it is not yet known exactly what the chelated density of calcium is, it has to be assumed that every carbonyl group has calcium attached to it. This upper limit can be estimated from the ratio of the repeat unit molecular weight to that of the repeat unit chelated to calcium, which is 0.84. The lowest number-averaged molecular weight reported in Table 4, measured from experimental number 89, was 13,333. Correction of this value for calcium chelation yields 11,200. The highest was 47,617, taken from experimental number 77P, which adjusts to 39,998 when corrected for calcium. From these estimates, it is believed that the aromatic polyurea fiber according to the present invention has attained molecular weights in this range. According to Yang (1991), the typical number-average molecular weight (Mn) of PPD-T is on the order of 20,000, which corresponds to a degree of polymerization of 84 and a chain repeat length of 108 nm. This suggests that by our simple laboratory method, we have met or exceeded the molecular weight of this commercially important polymer material. This is very important, since physical properties of the polyurea will not equate to or exceed those of Kevlar® (poly paraphenylene terephthalamide), unless its molecular weight is as high as, or higher than Kevlar® (poly paraphenylene terephthalamide).

It is also of interest to compare our measured values of polydispersity, listed above for the aromatic polyurea fiber of the present invention, to those reported for Kevlar® (poly paraphenylene terephthalamide). Again, according to Yang (1991), Mw/Mn ranges between 2 and 3. This is roughly half of the values measured for our polyurea, indicating that its distributions in molecular weight are much wider than that achieved for Kevlar® (poly paraphenylene terephthalamide).

### Example 10

### Molecular Modeling of Aromatic Polyurea Fiber

Molecular modeling of reactants, potential intermediates and oligomer products was conducted using HyperChem® version 5.0 from Hypercube. The purpose of these efforts was to gain insight into reaction chemistry and product properties to support conjectures that originated from experimental observations and analytical results and to build a coherent picture of the anticipated polyurea polymer derived from para-phenylene diisocyanate and para-phenylene diamine. Thus, early models were constructed to understand oligomer topology as the polymerization reaction proceeded in n-methylpyrrolidone. Later models involved potential constructions of end product structure; and these were supported, or validated, by simultaneous constructions of Kevlar® (poly paraphenylene terephthalamide) molecular structure

To achieve optimum physical properties in the currently-disclosed aromatic polyurea polymer, it is believed that molecular weight must be maximized. In such a reactive system as this, achieving high molecular weight is not necessarily a readily achievable goal. The growing molecule can quickly become entangled and knotted, and this limits access to reactive end groups by additional reactants. Thus, n-methylpyrrolidone became a logical choice as a solvent, and addition of calcium chloride as a stabilizing chelating agent.

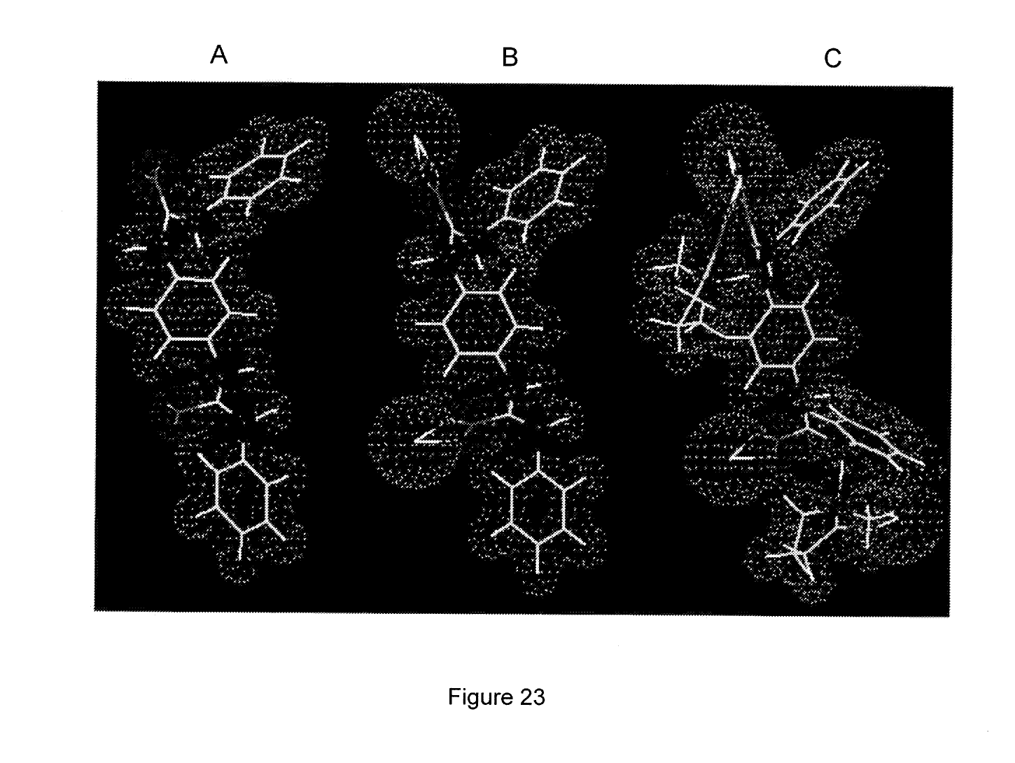

FIG. 23 shows a potential oligomer model containing two urea linkages. The image was rendered in “stick and dot” view, because this gave the clearest view of all atomic centers, bonds and the surrounding “electron cloud.” In this and subsequent model images, red shows the carbonyl oxygens with their two pair of non-bonding electrons; dark blue shows the nitrogen centers (the single non-bonding electron pair on each are difficult to see in these images, but they are present); light blue shows carbonyl and benzene ring carbons; and white lines show protons. These particular renderings do not show double bonds well, but they are present on the carbonyl and benzene-ring groups.

FIG. 23-B shows the same model after calcium ions (Ca⁺⁺, yellow) have attached to the carbonyl oxygen, non-bonding pairs; this calcium ion attachment occurs on carbonyl groups along the polymer backbone and on the NMP. These are temporary attachments, that seem to have little effect on the double bond structure of the carbonyl group. FIG. 23-C shows the model from B after attachment of the tertiary amine nitrogens of NMP to the urea hydrogens through hydrogen bonding from protons on the latter. Thus, B and C suggest how the growing polymer might be stabilized in NMP; all potential sites of hydrogen bonding are temporarily blocked by CA⁺⁺ and NMP. Each of these blocking agents keeps the polymer in suspension by reducing potential interaction with other nearby polymers. When Ca⁺⁺ and hydrogen-bonded NMP are removed by their stronger attraction to hydroxyl groups on water or an alcohol, the interpolymer hydrogen bonds readily form and the polymer readily drops from solution as a crystal, fiber, or film as the case may be.

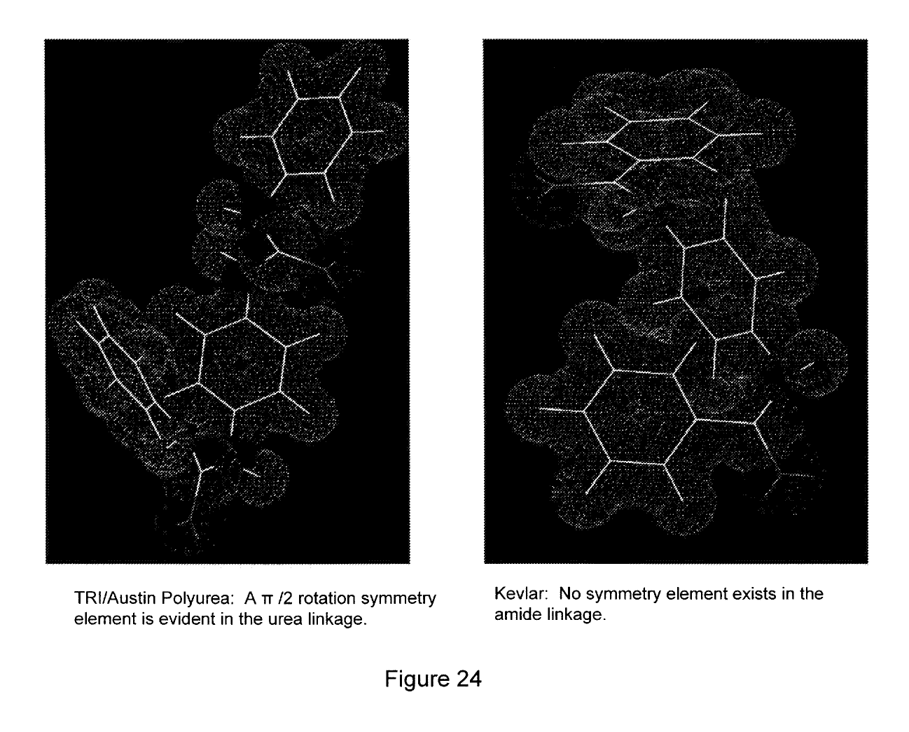

A related aspect of the work involved close examinations of molecular geometry in the urea linkage. Simultaneous examinations of analogous Kevlar® (poly paraphenylene terephthalamide) moieties were enlightening to understand potential differences in thermal and mechanical properties of these two materials based on differences in their structure. Thus, FIG. 24 shows oligomers of the two polymers spanning two linkage units each. The urea according to the current invention is shown at the top, the aramid in the bottom image.

The polyurea is capable of bi-dentate hydrogen bonding to the carbonyl oxygens of adjacent polymer chains. The aramid is only capable of mono-dentate hydrogen bonding. What is remarkable about observations from the modeling captured in FIG. 24 is that the additional nitrogen center in the urea linkage, compared to the linkage in Kevlar® (poly paraphenylene terephthalamide) seems to have little effect on overall structural morphology. Both oligomers remain roughly the same size in cross section and both appear to be twisted or “contorted” to the same degree. In the urea linkage, π/2 rotational symmetry is evident, but not in the amide linkage of the aramid.

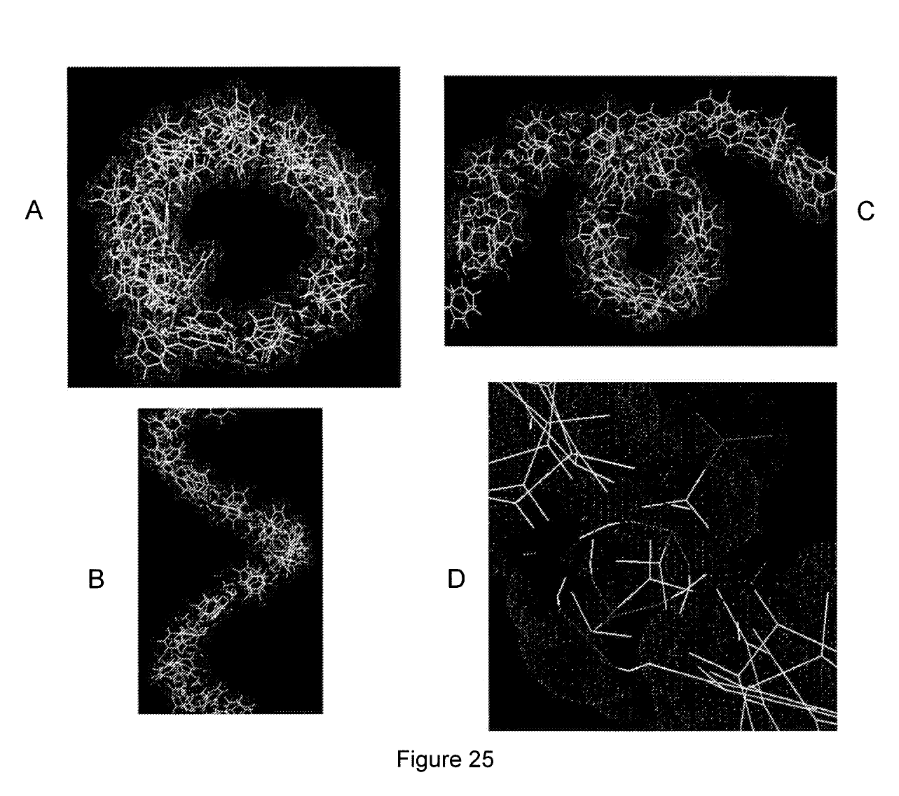

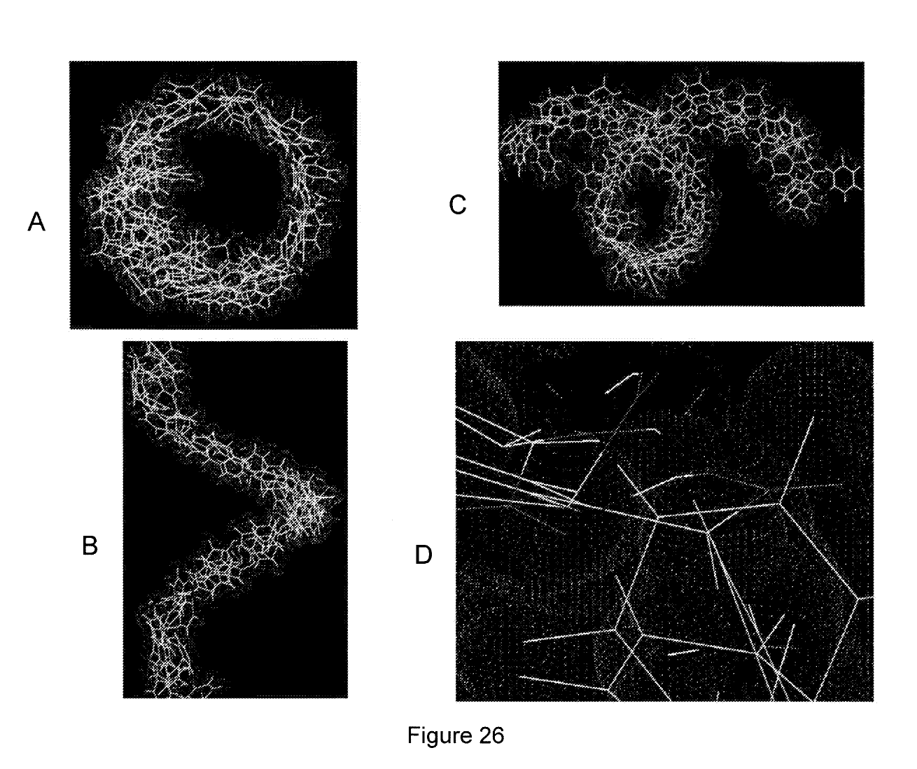

In the next two figures potential long-range polymeric structure of the polyurea in accordance with the instant invention (FIG. 25) and Kevlar® (poly paraphenylene terephthalamide) (FIG. 26) are shown. These models were constructed from only four polymer chains each, with each chain containing only 16 linkage units each. Both polymer models indicate the long-range structure may be represented by cork-screw spiral topology. In each of the two figures A shows the polymer structure along the chain growth axis; B shows the lateral view from an angle about 90° from axis; C shows a lateral oblique view with the corkscrew spiral evident; and D shows a close view of a cluster of linkage centers in the urea and aramid. In the later views (D in each case) the bi-dentate hydrogen bond structure is evident in the polyurea, as is the mono-dentate hydrogen bond in the polyaramid.

Without wishing to be bound by theory, it appears that other forms of hydrogen bonds are possible in both polymer structures; namely, hydrogen bonding between nitrogens on adjacent chains. Until now, only the possibility of intermolecular hydrogen bonding was considered, which is the modality whereby chains could be linked together in a fiber or strand of the polymer. These models also suggested the chains could become knotted and entangled when intra-molecular hydrogen bonds formed. These are more likely between nitrogen centers, due to their greater number, but also between nitrogen center and carbonyl, though formation of the latter is also further limited in possibility by geometric constraints. However, the hydrogen bond to carbonyl appears to be thermodynamically more favorable than between nitrogen centers based on these models.

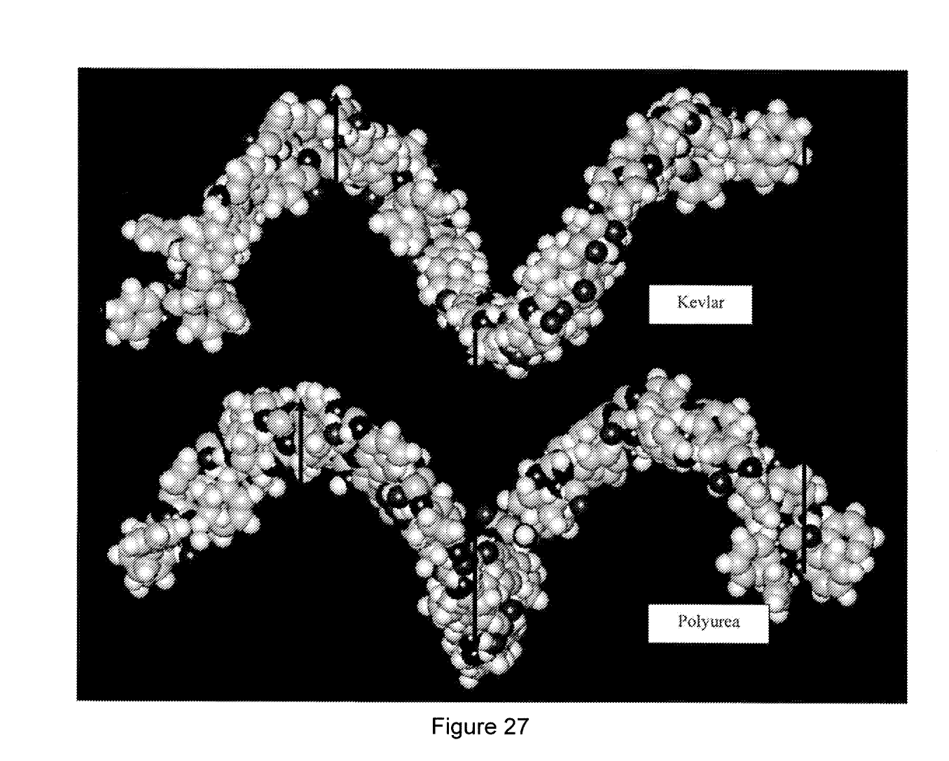

In FIG. 27 polyurea and polyaramid are shown in lateral view using an overlapping sphere rendering. Here, other potential differences in long-range structure may be evident, although the models presented thus far are based on four-chain structures. More chains bonded together, a likely scenario in reality, could alter these differences significantly. Nevertheless, the models shown in FIG. 27 hint at potential, subtle differences in long-range molecular structure that could result in differences in the physical properties of the two polymer materials. These differences would be results primarily of slight variations in their corkscrew topologies described further below. It is interesting that the second nitrogen center in the urea linkage results in the potential benefit of the bi-dentate hydrogen bond. However, the second center also induces a second turn in the polymer backbone that requires about four additional aramid repeat units to “catch up.” It is the additional kink the urea backbone, which may be the reason for the differences observed topology of the two corkscrews, and possibly long-range polymer structure.

The models shown in FIG. 27 were constructed from the same number of urea and aramid repeat units. The only difference between them is the second nitrogen center in each repeat unit of the urea. The section of aramid is shorter, which could be explained by the absence of all the second nitrogen centers, but it is not correspondingly shorter. In the distance spanned by about 1.5 periods of the aramid corkscrew spiral, almost two periods of the polyurea spiral are covered. In addition to this, the polyurea period is “shorter” than that of the aramid and its amplitude is slightly greater. In other words, the polyurea spiral requires longer axial distance to complete a cycle, and the diameter of its cycle is larger than that seen in the aramid. These geometric differences alone contribute to differences in the mechanical responses of these two “springs” to tensional forces.

A C2 symmetry element is evident in the urea linkage, while no symmetry element is present in the amide linkage. This distinction has structural implications which support the beneficial physical properties of the currently-disclosed aromatic polyurea fiber compared with those of polyaramids.

It is commonly thought that the presence of even minor symmetry within an aggregate structure increases the probability of long-range order within the aggregate. This is even more the case when the element of symmetry is repetitive. Recurrence of a symmetry element in the repeat units of a polymer has an ordering effect on the long-range spatial structure of the molecular chain. This in turn yields higher order within aggregates of the polymer, by improving dispersive contact and hydrogen bonding between the molecules. The C2 symmetry element in the urea linkage, and the absence of symmetry in a homologous amide, could therefore provide a beneficial differential in long-range order to aromatic polyureas, compared to aromatic polyamides.

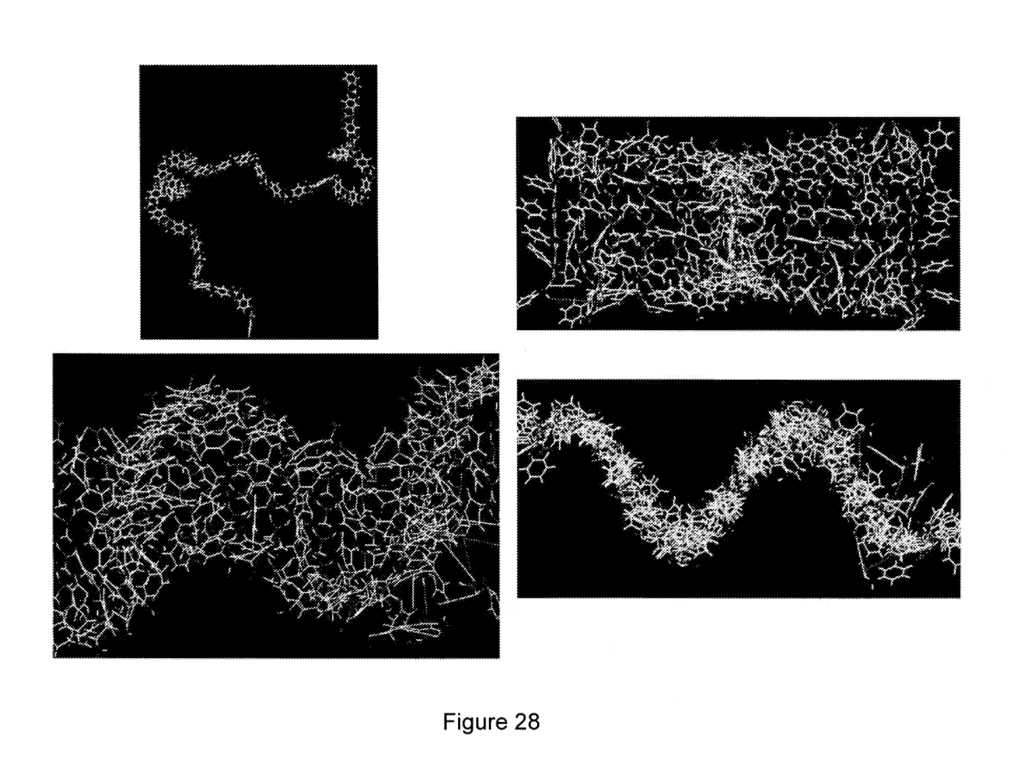

This concept of a symmetry element translating into long-range structured order within a polymer might be exemplified by an analogy to liquid versus solid water. In this case, water also has a C2 symmetry element. In its liquid form, any structured order is short-ranged and transient, because the molecules have thermal energy and are free to move. In the solid phase, the symmetry becomes “locked in” and long-range order is pervasive and often evident. Considering the results of some of the computer models of polyurea, this trend also seems feasible, as shown in FIG. 28. In this case, modeling of a single oligomer suggest short-range spiraling structure within the molecule, but more random structure over its entire length. When an aggregate of these molecules is compiled to represent the polymer in its solid form, long-range structure becomes apparent.

### Example 11

### Characterization of Polyurea Samples

Fourier Transform Infrared Spectroscopy (FTIR), proton Nuclear Magnetic Resonance Spectroscopy (NMR), Gel Permeation Chromatography (GPC) and elemental analysis were performed to characterize polymer samples from experiments 77c, 79c, and 57a, according to the present invention.

The proton NMR spectrum of Sample 77c is consistent with a small amount of p-phenylene diisocyante (PPDI) and p-phenylene diamine (PPDA) based aromatic polyurea in a large amount of N-methylpyrrolidone (NMP) solvent. The profile of the chemical shifts of polymer portion shows two broad single chemical shifts near 10 ppm [urea group, —NHC(O)NH—] and 7.5 ppm (aromatic positions). The very weak chemical shifts from end groups shown in the proton NMR spectrum are consistent with a p-phenylene amine. The approximate end Ar-amine groups in the polymer is about 12.3±1.2%.

The elemental (C, H, N, O) analysis results for Sample 57a (Table 3) and comparison with calculated element results (no end groups) are shown in Table 4.

TABLE 4
Elemental analysis results of sample “polymer solid 57A”

| | Results | Duplicate | Calculated results |
|---|---|---|---|
| Element | (wt. %) | (wt. %) | (wt. %) |
| Carbon | 59.54 | 58.91 | 62.68 |
| Hydrogen | 4.97 | 4.96 | 4.48 |
| Nitrogen | 19.23 | 19.53 | 20.90 |
| Oxygen | 14.00 | 13.85 | 11.94 |

The relative molecular weight (to polystyrene) for two liquid samples was measured with GPC, N-methylpyrrolidone (NMP) was used as the eluent. The summary of GPC analysis results are provided in Table 5.

TABLE 5
Summary of GPC analysis results of two “polymer solution
sample 77c” and “polymer solution sample 79c”.

| | | | | | Mw/Mn |
|---|---|---|---|---|---|
| Sample ID (Chemir #) | Mn | Mw | Mz | Mp | (Disp.) |
| Polymer Soln 77c (590592) | 53384 | 237237 | 618345 | 156433 | 4.44 |
| Polymer Soln 79c (590593) | 46614 | 158840 | 348288 | 135824 | 3.41 |

### FT-IR Analysis

Fourier Transform Infrared (FT-IR) Spectroscopy is a tool of choice for material identifications. In FT-IR, the infrared absorption bands are assigned to characteristic functional groups. Based on the presence of a number of such bands, a material under consideration can be identified. Availability of spectra of known compounds increases the probability of making a positive identification. Horizontal Attenuated Total Reflectance (HATR)-FT-IR probes for molecular structure at depth in polymer films.

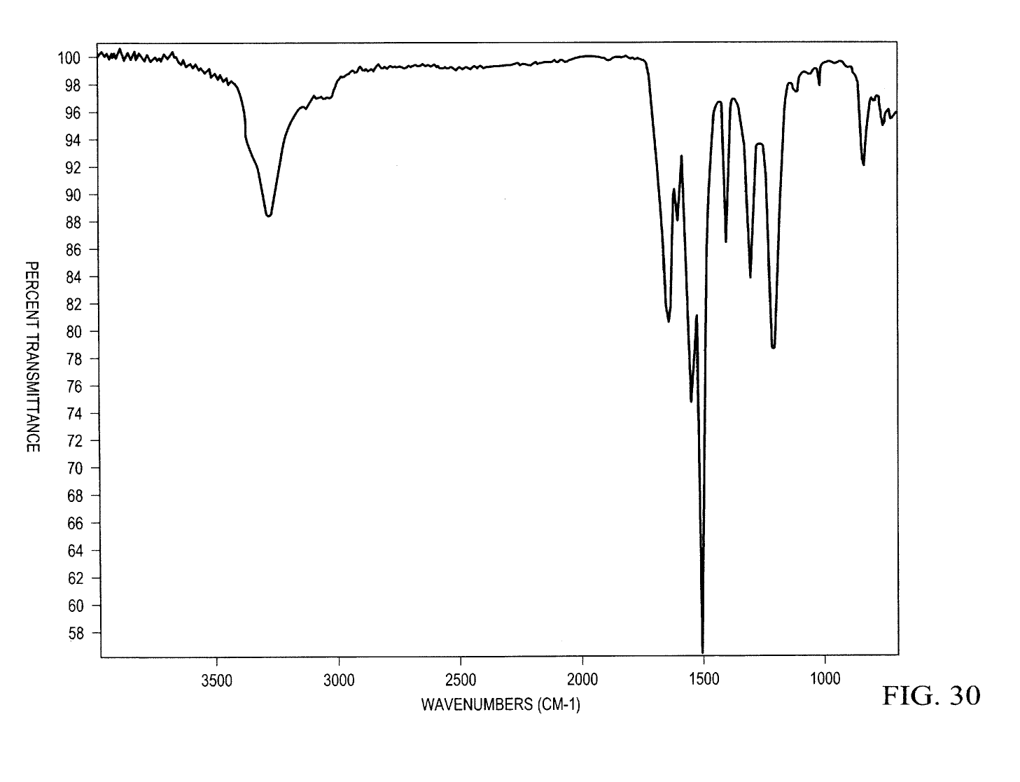

The (HATR)-FT-IR spectrum of the ‘as received’ sample “polymer solid 57a” is provided in FIG. 30.

### 1H NMR Analysis

NMR analysis is an important method of organic material characterization. The chemical shifts (NMR signals) of the nuclei of atoms in the molecule depend on the magnetic environment of NMR active nuclei and the local fields they experience. Since the chemical shifts of the active nuclei are determined by the local magnetic field, NMR methods provide valuable information at the atomic scale.

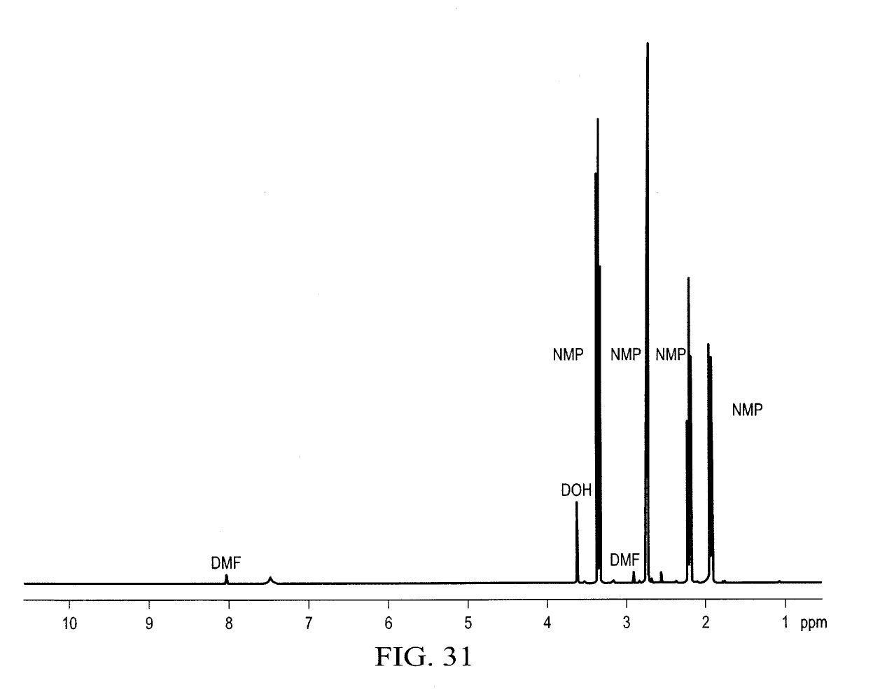

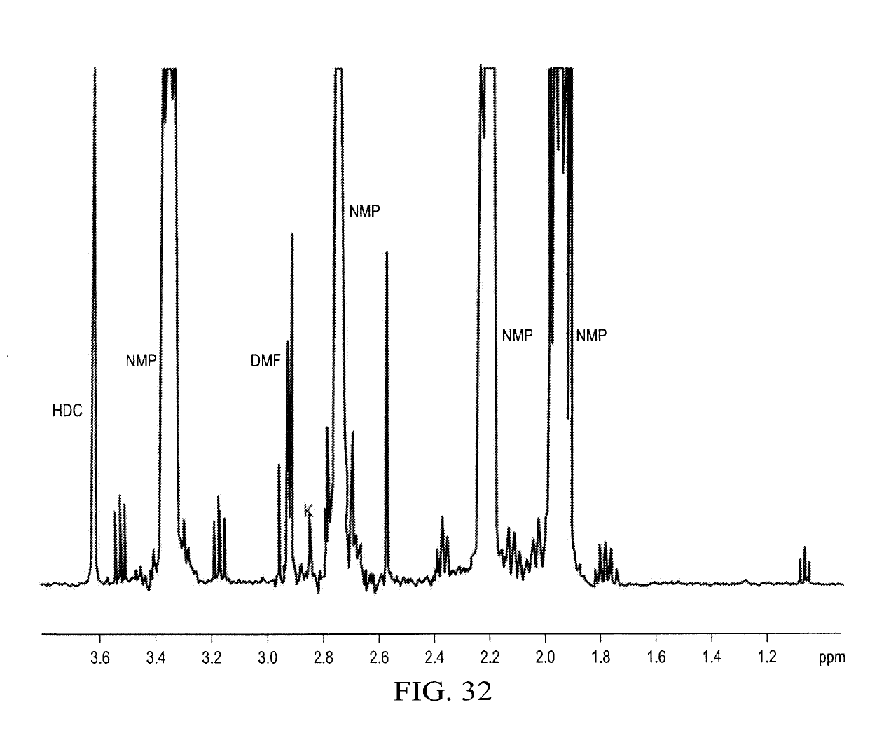

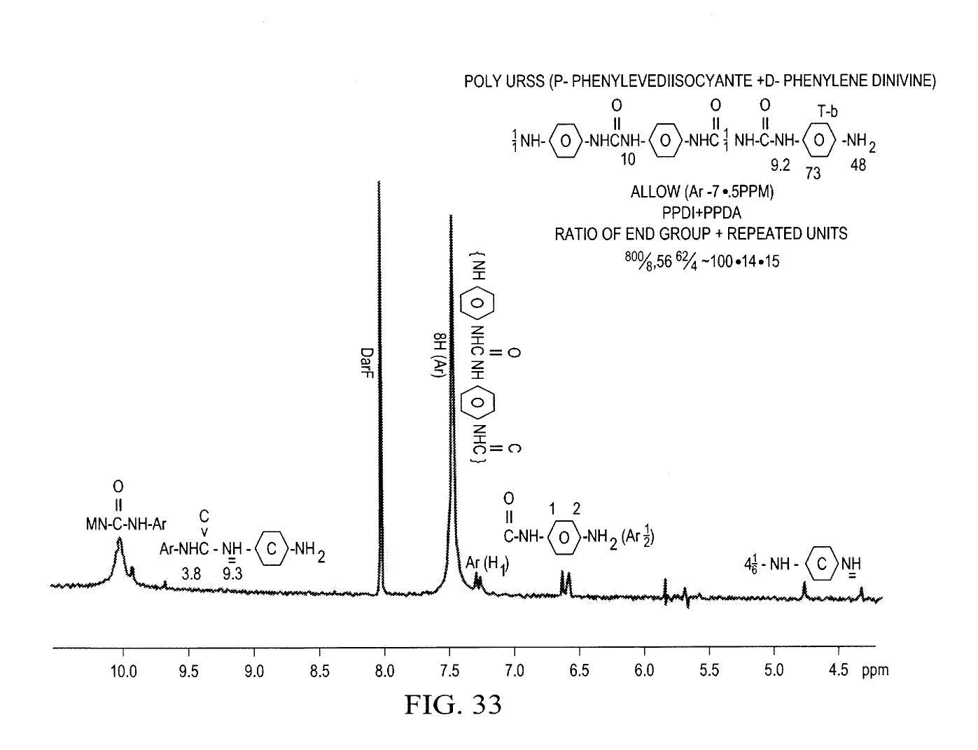

The proton NMR spectrum of the “as received” sample “polymer solution 77c” is provided in FIG. 31. Deuterium dimethylforamide (DMF-d7) was used as the solvent. The predominant chemical shifts located near 1.9, 2.2, 2.75 and 3.35 ppm are consistent with N-methyl-2-pyrrolidone (NMP) solvent. The sharp singlet at 3.61 ppm is due to water in the NMP. FIG. 32 and FIG. 33 expand FIG. 31 in the Y-axis region from 1 to 3.8 ppm (FIG. 32) and 4 to 11 ppm for details of the weak chemical shifts. The weak sharp multiple peaks shown in FIG. 32 are most likely due to isomers or impurities form NMP solvent. FIG. 33 presents the polymer portion in this sample, which is consistent with a p-phenylene diisocyanate (PPDI) and p-phenylene diamine (PPDA) based aromatic polyurea. The relatively strong and broad single peak centered near 7.5 is reasonably assigned to the aromatic protons, while the peak near 10 ppm is consistent with protons in the urea structure. The very weak chemical shifts near 4.8 (—NH₂), 6.6 and 7.25 (Ar protons), 9.7 and 9.95 ppm (urea protons) are assigned to terminal aromatic amines. The assignments are based on chemical shifts of similar chemical species available in the literature, which are marked in FIG. 33. The approximate ratio of end group in this sample would be an estimate based on integration of the peak areas at the characteristic chemical shifts. The calculations are shown below:

Ratio of repeated polyurea over end Ar-amine group: 800/8:56/4˜100:4

End Ar-amine %: ˜14/114×100%=12.3%

1.2% deviation was reported in conclusion in consideration of deviation of integration, especially for such weak chemical shifts for the end groups.

### Elemental Analysis

Elemental analysis is a measurement that determines the amount (typically as weight percent) of an element in a compound. Just as there are many different elements, there are many different methods for determining elemental composition. The most common type of elemental analysis is for carbon, hydrogen, and nitrogen (CHN analysis). This type of analysis is especially useful for organic compounds (compounds containing carbon-carbon bonds).

The elemental analysis was performed on the sample “polymer solid 57a.” A combustion method was used to determine total carbon, hydrogen, and nitrogen. Pyrolysis was the method used to determine content of oxygen in this sample. The analysis was duplicated and the results are summarized in Table 6.

TABLE 6
Elemental analysis results of sample “polymer solid 57a”

| | Results | Duplicate | Calculated results |
|---|---|---|---|
| Element | (wt. %) | (wt. %) | (wt. %) |
| Carbon | 59.54 | 58.91 | 62.68 |
| Hydrogen | 4.97 | 4.96 | 4.48 |
| Nitrogen | 19.23 | 19.53 | 20.90 |
| Oxygen | 14.00 | 13.85 | 11.94 |

### GPC Analysis

Gel Permeation Chromatography is used to determine the molecular weight of distribution of polymers. In GPC analysis, a solution of the polymer is passed through a column packed with a porous gel. The sample is separated based on molecular size with larger molecules eluting quicker than smaller molecules. The retention time of each component is detected and compared to a calibration curve, and the resulting data is then used to calculate the molecular weight distribution for the sample.

A distribution of molecular weights rather than a unique molecular weight is characteristic of all types of synthetic polymers. To characterize this distribution, statistical averages are used. The most common of these averages are the “number average molecular weight” (Mn) and the “weight average molecular weight” (Mw). The ratio of these two values (Mw/Mn) is referred to as the polydispersity index (PI). The larger the PI, the more disperse the molecular weight distribution is. The lowest value that a PI can have is 1, which represents a monodispersed sample—a polymer with all of the molecules in the distribution being the same molecular weight. Also sometimes included is the peak molecular weight, Mp. The peak molecular weight value is defined as the mode of the molecular weight distribution. It signifies the molecular weight that is most abundant in the distribution. This value also gives insight into the molecular weight distribution.

Most GPC measurements are made relative to a known polymer standard (usually polystyrene). The accuracy of the results depends on how closely the characteristics of the polymer being analyzed match those of the standard used. The expected error in reproducibility between different series of determinations, calibrated separately, is ca. 5-10% and is characteristic of the limited precision of GPC determinations. Therefore, GPC results are most useful when a comparison between the molecular weight distribution of different samples is made during the same series of determinations.

The summary of GPC analysis parameters and conditions are provided below:

| | |
|---|---|
| Pump: Waters 590 | Flow Rate: 0.75 mL/min |
| Injector: Waters 717 + WISP | Injection Vol: 100 uL |
| Detector 1: Waters 481 UV @265nm | Detector 2: Waters 410dRI @16x |
| Data: Millenium 2.10 on NEC | Sampling Rate: 1.0 point per |
| computer | second |
| Eluent: N-methylpyrrolidinone | |

Columns: Jordi Mixed Bed Linear 250 × 10 mm Cat#15025 #11060802
Reagents: NMP Aldrich [872-50-4] 270458 Lot #02047BH
Lithium Chloride Aldrich [7447-41-8] 213233 Lot#MKAA0678
Standards: 10 Polystyrene Standards (1220 Mp-1090000 Mp)

| | |
|---|---|
| Curve fit: Linear Correl = −0.9990 | |
| Sample: Polyurea in NMP | |
| Temperature: 85° C. | Sample Conc. < = : 0.15% |
| Sample Prep: Diluted 1:100 with eluent | |
| Results & Plot: Triplicate injections | Reference: None |

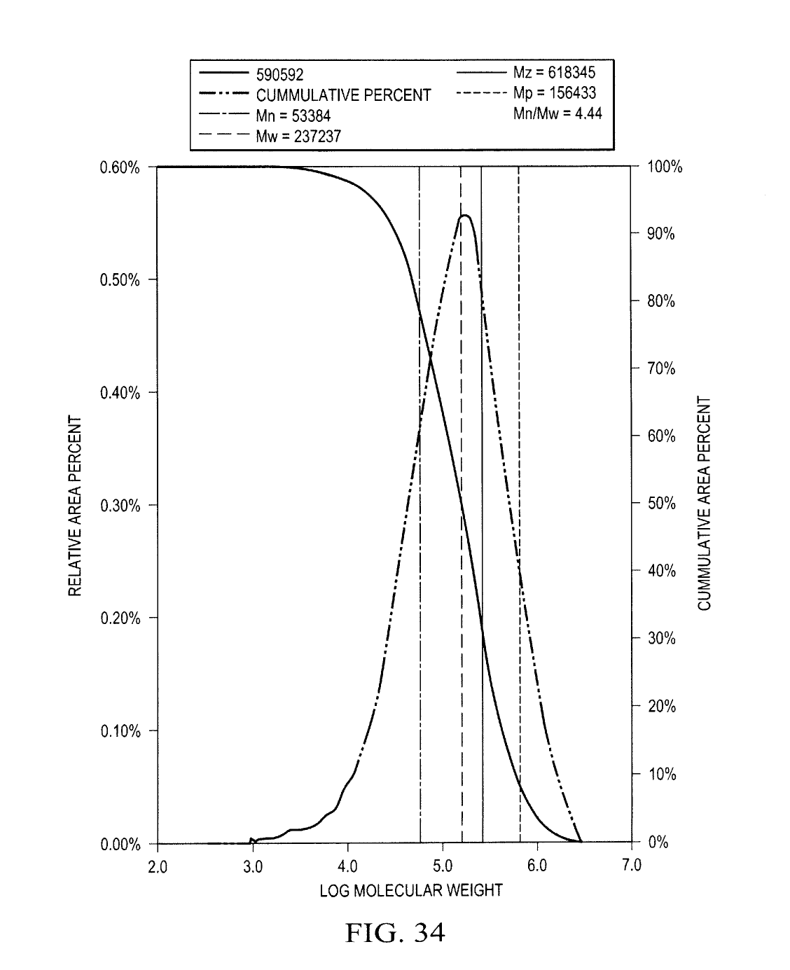

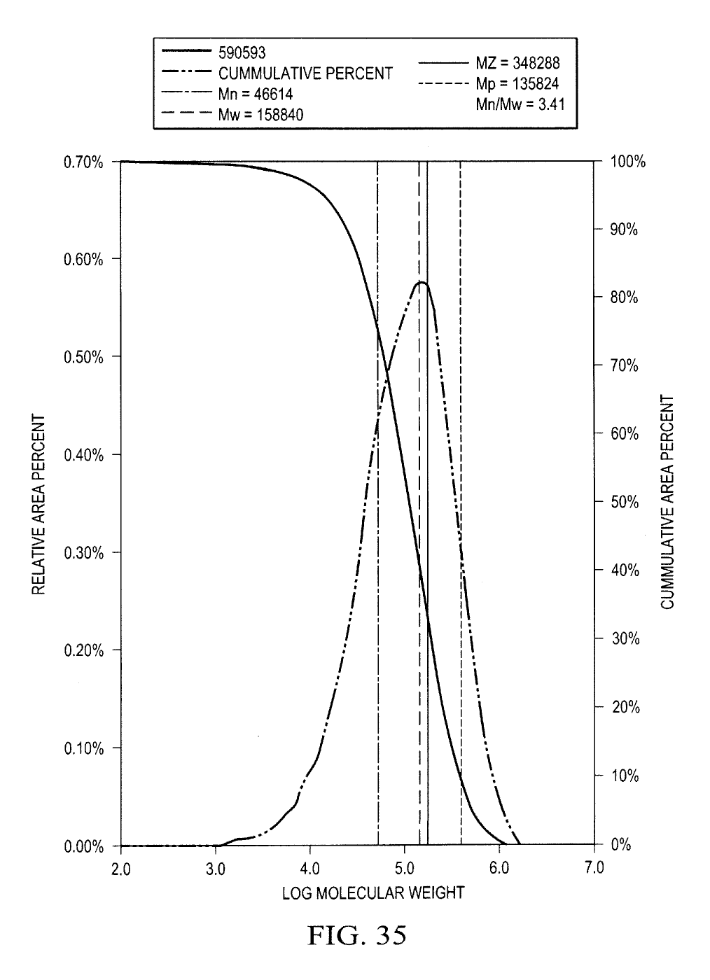

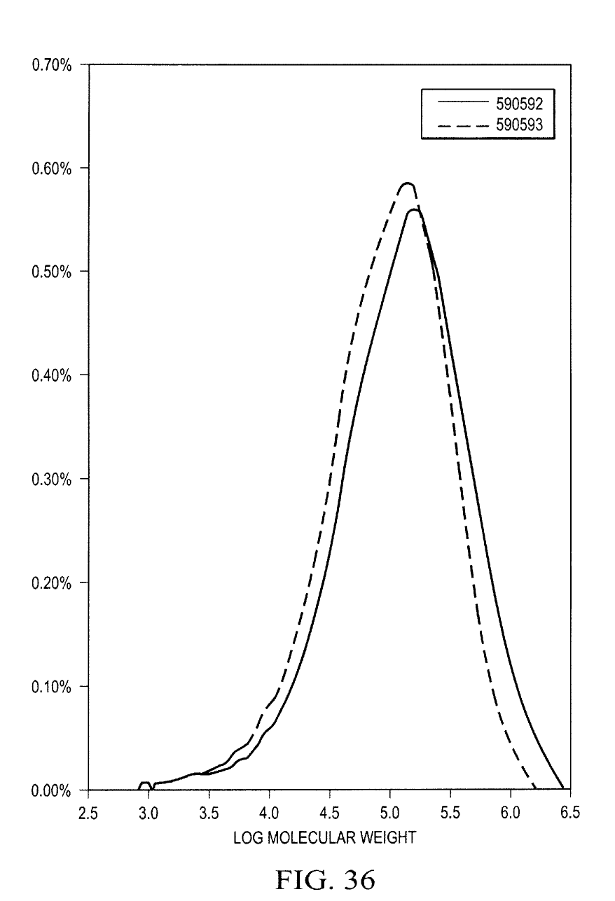

The results are provided in Table 7. The calibration curve and MWD curves of two samples are provided in FIG. 34, FIG. 35, and FIG. 36.

TABLE 7
Summary of GPC analysis results of polymer solution sample 77c and
polymer solution sample 79c.

| | | | | | Mw/Mn |
|---|---|---|---|---|---|
| Sample ID (Chemir #) | Mn | Mw | Mz | Mp | (Disp.) |
| Polymer Soln 77c (590592) | 53384 | 237237 | 618345 | 156433 | 4.44 |
| Polymer Soln 79c (590593) | 46614 | 158840 | 348288 | 135824 | 3.41 |

TABLE 8
Instrumentation

| Scientific | | |
|---|---|---|
| Instrument | Manufacturer/Model | Purpose |
| Fourier Transform | Nicolet/Magna 550 | Chemical compo- |
| Infrared Spectrom- | | sition analysis |
| eter (FT-IR) | | |
| Nuclear Magnetic | Varian/Mercury 400B | Material charac- |
| Resonance | | terization and |
| Spectrometer | | compositional |
| (NMR) | | analysis |
| Gel Permeation | Waters/590 pump 717 + WISP | MW and MWD |
| Chromatography | 481 UV detector | measurement |
| (GPC) | | |

### REFERENCES CITED

The following references, to the extent that they provide exemplary procedural or other details supplementary to those set forth herein, are specifically incorporated herein by reference.

### U.S. Patent Documents

U.S. Pat. No. 4,218,542 issued on Aug. 19, 1980, with Ukihashi et al. listed as inventors.
U.S. Pat. No. 4,433,067, issued on Feb. 21, 1984, with Rice et al. listed as the inventors.
U.S. Pat. No. 4,035,344, issued on Jul. 12, 1977, with Spiewak et al. listed as the inventors.
U.S. Pat. No. 5,414,118, issued on May 9, 1995, with Yosizato et al. listed as the inventors.
U.S. Pat. No. 5,401,825, issued on Mar. 23, 1995, with Kurtz et al. listed as the inventors.
U.S. Pat. No. 5,541,346, issued on Jul. 30, 1996, with Drysdale et al. listed as the inventors.

### Foreign Patent Documents

Japanese Patent No. 57002810, issued on Jan. 19, 1982, with Sasaki et al. listed as the inventors.
GB 1007334, published on Oct. 13, 1965, with Wander et al. listed as the inventors.
CH 525898, published on Jul. 31, 1972, with Hirt et al. listed as the inventors.
CH 479557, published on Oct. 15, 1969, with Hirt et al. listed as the inventors.
DE 1213553, published on Mar. 31, 1966, with Raab et al. listed as the inventors.
CH 520657, published on Mar. 31, 1972, with Hirt et al. listed as the inventors.
JP 09013068, published on Jan. 14, 1997, with Nakanishi et al. listed as the inventors.
JP 10044618, published Feb. 17, 1998, with Fukuoka et al. listed as the inventors.
DE 906213, published Mar. 11, 1954, with Seidenfaden et al. listed as the inventors.
JP 57042717, published Mar. 10, 1982, inventors not listed.
JP 2004149626, published May 27, 2004, with Yasuda et al. listed as the inventors.

### Non-Patent Documents

Billmeyer, F. W. 1984, Textbook of Polymer Science, Interscience Publishers, John Wiley & Sons, New York.
Gaymans R. J., 2003, Polyamides in Synthetic Methods in Step-Growth polymers, Chapter 3: 135-195, Edited by M. E. Rogers and T. E. Long Wiley-Interscience
Higashi, F., Goto M. and Kikinoki, H. 1980, Synthesis of Polyamides by a New Direct Polycondensation Reaction Using Triphenyl Phosphite and Lithium Chloride J. Polym Sci.: Polym. Chem. Ed. 18:1711-1717.
Higashi, F. Goto M. and Nakano, Y. 1980, Wholly Aromatic Polyamides by the Direct Polycondensation Reaction Using Triphenyl Phosphite in the Presence of Poly (4-Vinylpyridine), J. Polym Sci.: Polym. Chem. Ed. 18:851-856.
Katzhendler, J.; Cohen, S.; Rahamim, E.; Weisz, M.; Ringel, I.; Deutsch, J. 1989, The Effect of Spacer, Linkage, and Solid Support on the Synthesis of Oligonucleotides Sch. Pharm., Hebrew Univ. Jerusalem, Jerusalem, 91120, Israel. Tetrahedron 45(9): 2777-92.
Lewis, F. D.; Delos, S.; Grace, B.; Liu, W. 2005, Convergent Synthesis of Nonsymmetric π-Stacked Protophanes Assembled with Urea Linkers Journal of Ogranic Chemistry 70(8): 2974-79.
Macosko, C. W. 1989, RIM, Fundamentals of Reaction Injection Molding, Hanser Publishers, Munich.
National Materials Advisory Board (NMAB Opportunities for DoD-Sponsored Research) 2005, High-Performance Structural Fibers for Advanced Polymer Matrix Composites.
Patel, H. S. 1995, Novel Terpolymers: poly(keto-amine-ureas), International Journal of Polymeric Materials 28(1-4):161-9.
Petersen, S. 1949, Polyurethans. V. Low-molecular conversion products of diisocyanates. Justus Liebigs Annalen der Chemie 562:205-29.
Preston, J. and Hofferbert, W. L. 1979, Preparation of Polyamides via the Phosphorylation Reaction. II. Modification of Wholly Aromatic Polyamides with Trifunctional Monomers. J. Appl. Polym. Sci. 24:1109-1113.
Vollbracht, L. 1989, Aromatic Polyamides, Chapter 22 in Comprehensive Polymer Science: the Synthesis, Characterization, Reactions, Allen, G. ed., Pergamon Press.
Sheth, J. P., Klinedinst, D. B. Wilkes, G. L. Yilgor, I., and Yilgor, E. 2005, Role of chain symmetry and hydrogen bonding in segmented copolymers with monodisperse hard segments, Polymer 46:7817-7322.
Yang, H. H. 1991, Kevlar Aramid Fiber, John Wiley & Sons, New York.
Zabicky, J. 1970, The Chemistry of Amides, Interscience Publishers, John Wiley & Sons, London.

What is claimed:

1. An aromatic polyurea fiber comprising:
units of paraphenylene-diisocyante (PPDI) and paraphenylenediamine (PPDA) linked via urea linkages to form a polymer.

2. The aromatic polyurea fiber of claim 1, wherein the units of paraphenylene-diisocyante (PPDI) and paraphenylenediamine (PPDA) are alternating.

3. The aromatic polyurea fiber of claim 1, wherein the polymer has a number-averaged molecular weight of greater than approximately 10,000 g/mol.

4. The aromatic polyurea fiber of claim 1, wherein the polymer has a number-averaged molecular weight of greater than approximately 25,000 g/mol.

5. The aromatic polyurea fiber of claim 1, wherein the polymer has a number-averaged molecular weight of greater than approximately 45,000 g/mol.

6. An aromatic polyurea fiber comprising the following structure: 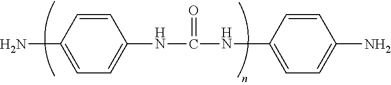
where n is approximately 50 or higher.

7. A method of producing an aromatic polyurea fiber, comprising the steps of:
a) adding a paraphenylene-diisocyante (PPDI) to anhydrous N-methyl-2-pyrrolidone (NMP) to form Solution A;
b) adding a paraphenylenediamine (PPDA) and dehydrated calcium chloride to anhydrous NMP to form Solution B;
c) combining Solution A and Solution B to form Solution C and mixing vigorously until a change in viscosity occurs in Solution C;
d) adding Solution C to a vortex of anhydrous ethanol to form Solution D; and
e) filtering Solution D to collect the aromatic polyurea fiber.

8. The method of claim 7, wherein the concentration of paraphenylene-diisocyante (PPDI) in anhydrous N-methyl-2-pyrrolidone (NMP) in Solution A is in the range of 10% to 50% by weight, based on NMP.

9. The method of claim 7, wherein the concentration of paraphenylene-diisocyante (PPDI) in anhydrous N-methyl-2-pyrrolidone (NMP) in Solution A is in the range of 20% to 40% by weight, based on NMP.

10. The method of claim 7, wherein the concentration of paraphenylene-diisocyante (PPDI) in anhydrous N-methyl-2-pyrrolidone (NMP) in Solution A is in the range of 20% to 25% by weight, based on NMP.

11. The method of claim 7, wherein the concentration of paraphenylenediamine (PPDA) in anhydrous N-methyl-2-pyrrolidone (NMP) in Solution B is in the range of 5% to 15% by weight, based on NMP.

12. The method of claim 7, wherein the concentration of paraphenylenediamine (PPDA) in anhydrous N-methyl-2-pyrrolidone (NMP) in Solution B is in the range of 5% to 10% by weight, based on NMP.

13. The method of claim 7, wherein the concentration of paraphenylenediamine (PPDA) in anhydrous N-methyl-2-pyrrolidone (NMP) in Solution B is in the range of 5% to 8% by weight, based on NMP.

14. The method of claim 7, wherein the concentration of calcium chloride in anyhydrous N-methyl-2-pyrrolidone (NMP) in Solution B is in the range of 10% to 40% by weight, based on NMP.

15. The method of claim 7, wherein the concentration of calcium chloride in anyhydrous N-methyl-2-pyrrolidone (NMP) in Solution B is in the range of 20% to 30% by weight, based on NMP.

16. The method of claim 7, wherein the concentration of calcium chloride in anyhydrous N-methyl-2-pyrrolidone (NMP) in Solution B is in the range of 20% to 25% by weight, based on NMP.

17. The method of claim 7, wherein the concentration of ethanol in Solution D is greater than 40 times the concentration of Solution C.

18. The method of claim 7, further comprising the step of rinsing the aromatic polyurea fiber with a ketone.

19. The method of claim 7, further comprising the step of drying the aromatic polyurea fiber in an oven.

20. The method of claim 19, wherein the temperature of the oven is approximately above approximately 30° C.
